(19) United States
(12) Patent Application Publication
(10) Pub. No.: US 2026/0297375 A1
(43) Pub. Date: Oct. 1, 2026

(54) REACTIVE COMPOSITIONS THAT INCLUDE ACID FUNCTIONAL COMPOUNDS AND COMPOSITIONS DERIVED THEREFROM

(71) Applicant: PPG Industries Ohio, Inc., Cleveland, OH (US)

(72) Inventors: Hilary Ann Kerchner, Allison Park, PA (US); Hongying Zhou, Allison Park, PA (US); Rachel Elizabeth Ramsey, Pittsburgh, PA (US); Brandon James Myrga, Pittsburgh, PA (US); Scott Joseph Moravek, Mars, PA (US); Francis Patrick Cassidy, Pittsburgh, PA (US); Chad Alan Landis, Oakmont, PA (US); Paul Hubert Lamers, Allison Park, PA (US); Brian Edward Woodworth, Glenshaw, PA (US); Ann Elizabeth Lindberg, Pittsburgh, PA (US); Dennis Leroy Faler, North Huntington, PA (US)

(73) Assignee: PPG Industries Ohio, Inc., Cleveland, OH (US)

(21) Appl. No.: 19/483,282

(22) PCT Filed: May 10, 2024
(86) PCT No.: PCT/US2024/028877

§ 371 Date: Nov. 11, 2025

Related U.S. Application Data
(60) Provisional application No. 63/501,999, filed on May 12, 2023.
(60) Provisional application No. 63/502,003, filed on May 12, 2023.
(60) Provisional application No. 63/502,014, filed on May 12, 2023.
(60) Provisional application No. 63/644,078, filed on May 8, 2024.

(51) Int. Cl. C09D 175/08; C08G 18/83; C09D 5/03

(52) U.S. Cl. CPC C09D 175/08; C08G 18/831; C08G 18/833; C08G 18/834; C09D 5/03

(57) ABSTRACT

A reactive composition that includes a first compound containing from 1 to 12, such as from 1 to 10, or from 1 to 6, or from 1 to 5 or from 1 to 4 carboxylic acid functional groups according to the structure: where R¹ can be a C₁ to C₆, such as a C₁ to C₄ or C₁ to C₃ linear or branched alkyl group and X can be O, S or NR², where R² can be H, methyl, ethyl, propyl or isopropyl. The reactive composition also includes a second compound that includes a functional group reactive with the carboxylic acid functional groups in the first compound. Also disclosed are compositions derived from the reactive composition and methods of making and using the reactive composition and compositions derived therefrom.

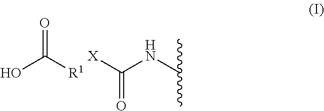

### CROSS-REFERENCE TO RELATED APPLICATION

This application claims the benefit of priority of the following U.S. Provisional Applications filed under 35 U.S.C 119: 63/644,078 filed May 8, 2024, titled “Reactive Compositions That Include Acid Functional Compounds and Compositions Derived Therefrom”; 63/502,003 filed May 12, 2023, titled “Curable Compositions Based on High Acid Value Polyurethanes”; 63/501,999 filed May 12, 2023, under 35 U.S.C. 119, titled “Curable Compositions Based on High Acid Value Resins Using Acid Cure Mechanisms”; and 63/502,014 filed May 12, 2023, titled “Curable Compositions Based on High Acid Value Resins Using Hybrid Cure Mechanisms” which are all incorporated herein by reference.

### FIELD

This disclosure generally relates to compositions that include acid functional compounds and compositions derived therefrom.

### BACKGROUND

Reactive compositions and compositions derived therefrom are used in many industrial, architectural and pharmaceutical applications. As nonlimiting examples, when the reactive compositions are curable, they can be use as coatings, adhesives, and sealants for a wide variety of industrial applications such as automotive, protective, marine, commercial transportation, consumer electronics, and many others for decorative and functional applications.

### SUMMARY

The present disclosure is directed to a reactive composition that includes a first compound containing from 1 to 12, such as from 1 to 10, or from 1 to 6, or from 1 to 5 or from 1 to 4 carboxylic acid functional groups according to structure (I):

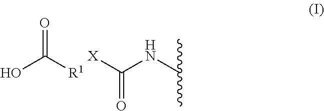

where R¹ can be a C₁ to C₆, such as a C₁ to C₄ or C₁ to C₃ linear or branched alkyl group and X can be O, S or NR², where R² can be H, methyl, ethyl, propyl or isopropyl. The reactive composition also includes a second compound that includes a functional group reactive with the carboxylic acid functional groups in the first compound.

The present disclosure also provides compositions derived from the reactive composition and methods of making and using the reactive composition and compositions derived therefrom.

### DETAILED DESCRIPTION

For the purposes of the following detailed description, it is to be understood that the disclosure may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

### I. Definitions

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses the singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “a” polymer, “an” acid, and the like refer to one or more of any of these items.

Unless otherwise indicated, ambient conditions of temperature and pressure are ambient temperature (20-25° C., such as 23° C.) and standard pressure of 101.3 kPa (1 atm) at a relative humidity in the air of 35% to 75%, such as 55%.

As used herein, “acid value on solids,” refers to a quantified acidity of a given chemical substance based on the milligrams (mg) of potassium hydroxide (KOH) required to neutralize the acidic constituents in 1 gram of the non-volatile components according to ASTM D 4662-15.

As used herein, “actinic radiation” refers to electromagnetic radiation capable of initiating photochemical reactions, such as, without limitation, UVB and UVC radiation (180-315 nm) and near-UV radiant energy in the 320-380 nm (or 400 nm) range.

As used herein, the term “adhesive” refers to a substance applied to one or both surfaces of two separate substrates that binds them together and resists their separation.

As used herein, “ambient reactive extrusion” (“ARE”) and like terms refer to an additive process whereby layers of material, such as a curable composition, are built up to create a three-dimensional part, such as creating a three-dimensional article by applying layer on top of layer of a curable composition. ARE may use coreactive compositions; that is, at least two components that react with each other (i.e., are “coreactive”), as a nonlimiting example a first compound containing a carboxylic acid functional group and a second compound containing a functional group reactive with the carboxylic acid functional group, when extruded in combination and/or succession, chemically react with one another to form a curable composition. The curable composition may thereafter cure under cure conditions, such as exposure to heat, actinic radiation, catalysts, addition of curing agents-post extrusion, and the like to form an article, including a portion of an article of manufacture.

As used herein, “amine” refers to a group in a molecule generally conforming to the structure —NR₂, where each R can independently be H or a carbon-based group. When both of the R groups are H, the amine is a “primary amine”, when one of the R groups is H, the amine is a “secondary amine”, and when both of the R groups are carbon-based groups, the amine is a “tertiary amine”.

As used herein, the term “ASTM” refers to publications of ASTM International, West Conshohocken, PA.

As used herein, the term “aziridine” refers to a molecule that includes one or more heterocyclic three-member ring moieties containing one nitrogen atom.

As used herein, the terms “backbone” and “polymer backbone” refer to the main chain of monomeric “repeat units” making up the main chain of a polymer.

As used herein, the terms “blocking group” or “blocked” refer to reacting a functional group with a molecule resulting in a derivative of the functional group that can be reversed, producing the original functional group. Blocking groups can be used, as a nonlimiting example, to reduce the activity of a group in a one-component system to increase its shelf life. A nonlimiting example of a blocking group includes reacting a carboxylic acid group with a lower alkyl alcohol to provide the corresponding ester.

As used herein, the term “base molecule” or similar terms, refers to a non-polymeric carbon based molecule that can optionally include hetero atoms that can include pendant functional groups.

As used herein, “carbodiimide” refers to a molecule containing a moiety the structure: —N═C═N—. A “polycarbodiimide” refers to a molecule having more than one such moiety.

As used herein, “catalyst” refers to a substance that increases the rate of a chemical reaction without itself undergoing any permanent chemical change.

As used herein, “chiral center” refers to an atom in a low molecular weight molecule (less than 2,000 g/mol) that has four different atoms or groups attached to it. When a molecule includes multiple chiral centers and all of the chiral centers are of opposite R/S configuration between two “stereoisomers” (same molecular formula, same connectivity, different arrangement of atoms in space), they are “enantiomers”. If at least one, but not all of the chiral centers are opposite between two stereoisomers, they are “diastereomers”. Enantiomers are mirror images of each other and non-superimposable, diastereomers are not mirror images of each other and are non-superimposable. A “racemic mixture” is a 50:50 mixture of two enantiomers.

As used herein, the term “coating” refers to the finished product resulting from applying one or more coating compositions to a substrate and forming the coating, as a nonlimiting example by curing. A primer coat, basecoat or color coat layer and clear coat layer can comprise part of a coating. As used herein, the term “coating layer” is used to refer to the result of applying one or more coating compositions on a substrate in one or more applications of such one or more coating compositions. As a nonlimiting example, a single coating layer, referred to as a “color coat” or “topcoat” can be used to provide the function of both a basecoat and a clearcoat and can comprise the result of two or more applications of a color coat coating composition.

As used herein, the term “coating composition” refers to a composition that forms a protective and/or decorative layer on a substrate and can be a one-component, two-component or multicomponent composition.

As used herein, the term “colorant” refers to any substance that imparts color and/or other opacity and/or other visual effect to a coating composition and can include, without limitation dyes and pigments.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of the disclosure.

As used herein, the terms “crosslinker” and “crosslinking agent”, used interchangeably, refers to a molecule or polymer containing functional groups that are reactive with the crosslinking-functional group of the polymers and/or resins in the coating composition.

As used herein, the term “crosslinking-functional group” and similar terms refer to functional groups that are positioned in a molecule or the backbone of a polymer, often, in a group pendant from the backbone of the polymer, terminally positioned on the backbone of the polymer, or combinations thereof, wherein such functional groups are capable of reacting with other crosslinking-functional groups or separate crosslinking agents during curing to produce a crosslinked coating.

As used herein, the terms “curable”, “cure”, and the like, as a nonlimiting example, as used in connection with a coating composition, refer to at least a portion of the components that make up the coating composition are polymerizable and/or crosslinkable, via a covalent bond-forming reaction, when, as a nonlimiting example, exposed to higher temperatures or ultraviolet radiation.

As used herein, the terms “cyclic compound” and “cyclic moiety” refer to a molecule or portion of a molecule in which one or more series of atoms in the molecule are connected to form a ring.

As used herein the term “dye” refers to a colored substance, in many cases an organic compound, that can chemically bond to a substrate or another component in a coating composition.

As used herein the term “curing agent” refers to a compound that is able to participate in a chemical reaction that results in crosslinking and/or polymerization between monomers, oligomers, and/or polymers.

As used herein the term “elastomer” refers to a material, that can include long chainlike molecules (at least 100 carbon atoms long), or polymers, that are capable of recovering at least part of their original shape after being stretched.

As used herein the term “end group” refers to a functional group positioned at an end of a polymer backbone or at an end of an aliphatic chain.

As used herein the term “epoxy” refers to a molecule that includes one or more glycidyl or oxirane groups. The term “diepoxy” refers to a molecule that includes two epoxy groups. The term “epoxy-terminated compound” refers to a molecule where the epoxy group is at an end of the molecule. Epoxy equivalent weight (EEW) can be determined according to ASTM D1652-11 (2019) and unless otherwise indicated reported as g/eq.

As used herein the term “filler” refers to substances solid at ambient temperature added to various materials such as coatings, adhesives, sealants, plastics, rubber, glass, and/or metals that can make them easier to apply, mold, shape and/or enhance certain properties of the material while ensuring the stability of the material. Nonlimiting examples of fillers include minerals such as calcium carbonate, silica, clay, kaolin and carbon black.

As used herein, the terms “flash” or “flash off” refers to removal of solvents, that allow an applied coating composition to remain in a liquid state, to evaporate.

As used herein the terms “free-radical catalyst” and free-radical initiator” refer to compounds that decompose into free radicals and cause reactions to occur. Nonlimiting examples of free radical initiators include azo initiators such as 2,2′-azobis(isobutyronitrile) (AIBN), peroxides such as benzoyl peroxide (BPO), and redox initiators such as persulfate salts. Suitable actinic radiation activated, or photoinitiators, include, without limitation, (Norrish) Type I and Type II photoinitiators, such those available under the tradename OMNIRAD from IGM Resins.

As used herein, the term “hetero atom” and similar terms refer to atoms along the main chain of a carbon-based base molecule or polymer that are not carbon, as nonlimiting examples, oxygen in a polyether molecule or sulfur in a thioether molecule.

As used herein, the term “(hydroxylalkyl) urea” refers to molecules that contain a single urea group, at least two hydroxyl groups, and have at least two carbon atoms disposed between the urea group and each of the hydroxyl groups.

As used herein, the term “hydroxyl functional compound” refers to an organic compound containing one or more hydroxyl (—OH) groups.

As used herein, the terms “Isocyanate equivalent weight” and “NCO equivalent weight” refer to, unless otherwise stated, the isocyanate (NCO) equivalent weight (in grams per equivalent; g/eq) determined using ASTM D2572-19 (Standard Methods of Isocyanate Groups in Urethane Materials or Prepolymers) revised as described herein.

As used herein, the term “isocyanate reactive compound” refers to a molecule that includes at least one group, such as, without limitation, hydroxyl, primary or secondary amine and/or thiol, that is reactive with an isocyanate group.

As used herein, the term “low molecular weight molecule” refers to molecules that do not fit the definition of a polymer or oligomer and typically have a molecular weight of less than 2,000 g/mol.

As used herein, the term “mercaptopropionic acid” unless otherwise specified, refers to either or both of 3-mercaptopropionic acid and 2-mercaptopropionic acid.

As used herein, the term “(meth)acrylate” and like terms refer to molecules and moieties derived from acrylic acid, acrylate esters, methacrylic acid, methacrylate esters, or both.

Unless otherwise indicated, as used herein, the term “molecular weight” refers to a weight average molecular weight (“Mw”) as determined by gel permeation chromatography (GPC) using appropriate polystyrene standards. If a number average molecular weight (“Mn”) is specified, the weight is determined in the same GPC manner, while calculating a number average from the thus obtained polymer molecular weight distribution data. Mn refers to the total weight of a material divided by the number of molecules in the material and can be determined using gel permeation chromatography. Unless otherwise noted, Mw and Mn are in units of g/mol.

As used herein the term “monomer” refers to a molecule that can react together with other monomer molecules, through polymerization processes, to form a larger polymer chain or three-dimensional network.

As used herein the terms “multi component”, “multi-K” and “multi-pack” refers to a coating composition that includes a first component that contains crosslinkable resins, a second component that contains crosslinking agents and additional components that may or may not contain crosslinkable resins or crosslinking agents, where the components are maintained separately until just prior to use. The crosslinkable resins and crosslinking agents are capable of reacting when combined to form a thermoset composition. When the multi component coating composition does not include additional components, it is a two-component or 2-K coating composition.

As used herein the terms “one component”, “1-K” and “1-pack” refer to a coating composition where all of the coating components are maintained in the same package after manufacture, during shipping and storage and are maintained in the same container after manufacture, during storage, and the like, and may remain stable (not substantially react or gel) for longer than 1 month at conditions of 40-120° F. (4-49° C.) at 0-95% relative humidity, such as longer than 3 months, longer than 6 months, longer than 9 months, or longer than 12 months.

As used herein the term “organic filler” refers to carbon containing or naturally derived materials that can be added to other materials, such as polymers and plastics, to act as a filler and/or alter their properties.

As used herein, the term “organic solvent” refers to carbon-based substances capable of dissolving or dispersing other substances.

As used herein the term “oxazoline” refers to molecules that include a derivative of a five-membered heterocyclic organic moiety with the formula C₃H₅NO.

As used herein, the terms “pendant group” and “side group” refer to a group of atoms or functional group attached to a backbone chain of a base molecule or polymer.

As used herein, the term “pigment” refers to a colored material, often an inorganic compound, that is insoluble in a solvent at ambient conditions.

As used herein, the term “polymer” includes homopolymers (formed from one monomer) and copolymers that are formed from two or more different monomers or that comprise two or more distinct repeat units. Further, the term “polymer” includes prepolymers, and oligomers. The term “polymer backbone” refers to the atoms or monomeric repeat units arranged in a long chain and does not include pendant groups. The term “polymeric composition” refers to a compound or resin that includes at least one polymer and/or at least one other material.

As used herein, “polyol” refers to a compound having two or more hydroxyl groups, such as two, three or four hydroxyl groups.

As used herein the prefix “poly” refers to two or more. As a nonlimiting example, a polyisocyanate refers to a compound that includes two or more isocyanate groups and a polyol refers to a compound that includes two or more hydroxyl groups.

As used herein, the term “powder composition” refers to a reactive composition that includes solid particulates and less than 10 wt. %, based on the weight of the powder composition, of water or solvent.

As used herein, the term “rheology modifier” refers to a material that alters the rheological properties of a fluid composition to which it is added.

As used herein, the term “ring units” refers to the number of atoms in a ring structure. As nonlimiting examples, cyclohexane, benzene and pyridine would have six ring units. In the example of pyridine, one ring unit would be the hetero atom nitrogen.

As used herein, the term “sealant” refers to a material used for sealing a substrate so as to make it airtight or watertight, such that air or water do not infiltrate to the substrate.

As used herein, the term “reactive composition” refers to a combination or mixture that includes a first compound containing a functional group and a second compound containing a functional group capable of undergoing a chemical reaction with the functional group in the first compound.

As used herein, the term “solids” refers to the non-volatile (does not evaporate at ambient conditions) portion of a composition.

As used herein, the term “solvent resistance” refers to evaluating the degree of cure of a coating film by determining the film's resistance to a specified solvent. As used herein the solvent used is methyl ethyl ketone (MEK) and the method disclosed herein evaluates the film's resistance or degree of cure as “MEK double rubs”.

As used herein, the term “substrate” refers to an article surface to be coated and can refer to a coating layer that has been previously disposed on an article, which is also considered a substrate.

As used herein, the term “solvent” refers to a substance capable of dissolving or dispersing other substances at ambient conditions.

As used herein, the terms “terminal group” and “end group” refer to a moiety or functional group attached at an end of a carbon chain (“terminal position”).

As used herein, the term “thermosetting” means a polymer or resin that has functional groups that react with functional groups in a crosslinking agent or another polymer or molecule to form a network material, irreversibly transforming the “soft” polymer to a more rigid form. Thermosetting in many cases refers to resins that “set” irreversibly upon curing or crosslinking, wherein the polymer chains of the resins are joined together by covalent bonds. Once cured or crosslinked, a thermosetting resin will not melt upon the application of heat and is insoluble in solvents.

As used herein the term “thermoplastic” refers to polymers and resins that are not joined by covalent bonds and, thereby, can undergo liquid flow upon heating and can be soluble in certain solvents.

As used herein, the term “total neutralization” refers to complete neutralization where all the H⁺ ions from an acid, such as a carboxylic acid are neutralized by the same amount of a base.

As used herein, the term “total solids” or “solids” or “solids content” refers to the solids content as determined in accordance with ASTM D2369-20.

As used herein, the term “thioether group” refers to a functional group characterized by a sulfur atom bonded to two carbon atoms of any hybridization.

As used herein, the term “thiol” refers to a molecule that includes one or more

—SH groups. The term “polythiol” refers to a molecule that includes two or more thiol groups.

As used herein, “ultraviolet radiation” and “ultraviolet light” refer to electromagnetic radiation capable of initiating photochemical reactions, such as, without limitation, UVB and UVC radiation (180-315 nm) and near-UV radiant energy in the 320-380 nm (or 400 nm) range.

As used herein, unless otherwise indicated, the term “Viscosity” refers to a value determined at 23° C. and ambient pressure and reflects a fluid's resistance to flow when subjected to a shear stress and/or a shear strain; viscosity can be measured using a Brookfield Viscometer (AMETEK.Inc.) using spindle No. 7 at 50 rpm.

As used herein, the phrase “wt. %” refers to weight percent.

### II. Reactive Composition

The reactive composition according to this disclosure includes:
a first compound containing from 1 to 12, such as from 1 to 10, or from 1 to 6, or from 1 to 5 or from 1 to 4 carboxylic acid functional groups according to structure (I):

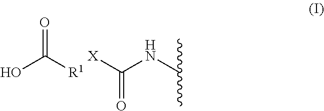

where R¹ can be a C₁ to C₆, such as a C₁ to C₄ or C₁ to C₃ linear or branched alkyl group and X is O, S or NR², wherein R² is H, methyl, ethyl, propyl or isopropyl; and
a second compound that includes a functional group reactive with the carboxylic acid functional groups in the first compound.

While not being limited to any single theory, the activity of the first compound that includes acid functional groups can be enhanced if the acid functional group is in close proximity, i.e. within 1 to 6, such as 1-4, or 1-3 carbon atoms of a urethane, urea, thiourea, or thiourethane group compared with a first compound where the acid functional groups are spaced greater than 6 carbon atoms from a urethane, urea, thiourea, or thiourethane group or that do not include a urethane, urea, thiourea, or thiourethane group. While not being limited to any single theory, it is believed that the enhanced activity allows the compounds that include acid functional groups to react or cure at lower temperatures. It is further believed that the proximity provides for the carbonyl in the urethane, urea, thiourea, or thiourethane group to interact with the acid functional groups to further enhance activity.

### A. The First Compound

The first compound can be molecular, or non-polymeric, or it can be a polymer. As such the first compound can include a base molecule and/or a polymer backbone.

The first compound can be a liquid at ambient conditions or have a melting point of at least about 30° C., such as at least about 50° C., or at least about 80° C. and can be up to about 120° C., such as up to about 110° C. or up to about 100° C. or within any range using any two of the foregoing values as endpoints, such as from 30° C. to 120° C., or from 30° C. to 110° C., or from 50° C. to 100° C.

When the first compound is non-polymeric, it can have a molecular weight of less than 2,000 g/mol, such as less than 1,500 g/mol, or less than 1,000 g/mol, or less than 750 g/mol, or less than 500 g/mol, where molecular weight is determined by summing the atomic weights of the individual atoms making up the first compound.

When the first compound includes a base molecule, the base molecule can include a molecular chain of from 6 to 60, such as from 6 to 50, or from 6 to 40 linear, branched, cyclic and/or aromatic carbon atoms and can optionally include a hetero atom such as O, S or NR⁵, where R⁵ is H, methyl, ethyl, propyl or isopropyl. The carboxylic acid functional groups in the first compound can be an end group or pendant from the base molecule.

The base molecule can include a cyclic moiety containing from 5 to 14, such as from 6 to 12 or 6 to 10 ring units, wherein, optionally some of the ring units contain a hetero atom and the remaining ring units comprise carbon.

The first compound may additionally include, hydroxyl groups, thiol groups, or any combination of the foregoing.

As indicated above, first compound contains one or more carboxylic acid groups and can be a polymer. The acid value of the first compound may be determined using a Metrohm 798 MPT Titrino automatic titrator, manufactured by Metrohm AG, according to ASTM D4662-15. The value may be then divided by the content of solids to result in acid value on solids. As such, the present polymer can have an acid value of from 10 mg KOH to 250 mg KOH, such as from 20 mg KOH to 225 mg KOH, or from 25 mg KOH to 200 mg KOH on solids according to ASTM D 4662-15.

The carboxylic acid functional group can be a reaction product of an isocyanate or polyisocyanate and a compound that includes a carboxylic acid group and a hydroxyl, a carboxylic acid group and a thiol and/or a carboxylic acid group and an amine.

The first compound can include, without limitation, a reaction product of isophorone diisocyanate and mercapto propionic acid, a reaction product of isophorone diisocyanate trimer and mercapto propionic acid, a reaction product of hexamethylene diisocyanate trimer and mercapto propionic acid, a reaction product of dicyclohexylmethane diisocyanate and mercapto propionic acid, a reaction product of hexane diisocyanate and mercapto propionic acid, a reaction product of tetramethylxylylene diisocyanate and mercapto propionic acid, a reaction product of isophorone diisocyanate and hydroxypropionic acid, a reaction product of Isophorone diisocyanate trimer and hydroxypropionic acid, a reaction product of hexamethylene diisocyanate trimer and hydroxypropionic acid, a reaction product of dicyclohexylmethane diisocyanate and hydroxypropionic acid, a reaction product of hexane diisocyanate and hydroxypropionic acid, a reaction product of tetramethylxylylene diisocyanate and hydroxypropionic acid, a reaction product of isophorone diisocyanate and hydroxy pivalic acid, a reaction product of isophorone diisocyanate trimer and hydroxy pivalic acid, a reaction product of dicyclohexylmethane diisocyanate and hydroxy pivalic acid, a reaction product of hexane diisocyanate and hydroxy pivalic acid, a reaction product of tetramethylxylylene diisocyanate, hydroxy pivalic acid, a reaction product of a cyclic carbonate and a carboxylic acid containing amine, a reaction product of triphenylmethane triisocyanate and mercapto propionic acid, a reaction product of toluene-2,4,6-triyl triisocyanate, and mercapto propionic acid, a reaction product of a tetraisocyanate according to the structure C(CH₂O(CH₂CH₂O)nCH₂CH₂NCO)₄, wherein n is from 1 to 20, and mercapto propionic acid, a reaction product of triphenylmethane triisocyanate and hydroxypropionic acid, a reaction product of toluene-2,4,6-triyl triisocyanate, and hydroxypropionic acid, a reaction product of a tetraisocyanate according to the structure C(CH₂O(CH₂CH₂O)nCH₂CH₂NCO)₄, wherein n is from 1 to 20, and hydroxypropionic acid, a reaction product of triphenylmethane triisocyanate and hydroxy pivalic acid, a reaction product of toluene-2,4,6-triyl triisocyanate, and hydroxy pivalic acid, and/or a reaction product of a tetraisocyanate according to the structure C(CH₂O(CH₂CH₂O)nCH₂CH₂NCO)₄, wherein n is from 1 to 20, and hydroxy pivalic acid. When the first compound includes a polymer, it can include a polymer that includes urethane, urea, thiourea, or thiourethane repeat groups, (meth)acrylate repeat groups, ester repeat groups, amide repeat groups, and/or carbonate repeat groups.

When the first compound includes a polymer, the polymer can have a weight average molecular weight of from 2,000 g/mol to 50,000 g/mol, such as from 2,500 g/mol to 40,000 g/mol, or from 3,000 g/mol to 30,000 g/mol determined by gel permeation chromatography using polystyrene standards.

The reactive composition of the present disclosure may include an amount of the first compound of from 10 wt. %, such as from 15 wt. %, such as from 20 wt. %, such as from 30 wt. %, such as from 40 wt. %, such as from 50 wt. %, or from 60 wt. % up to 85 wt. %, such as up to 85 wt. %, such as up to 80 wt. %, or up to 70 wt. %, or within any range using any two of the foregoing values as endpoints, such as from 10 wt. % to 85 wt. %, or from 15 wt. % to 85 wt. %, or from 20 wt. % to 80 wt. %, or from 30 wt. % to 80 wt. %, or from 30 wt. % to 70 wt. %, or from 40 wt. % to 70 wt. %, or from 50 wt. % to 80 wt. %, or from 60 wt. % to 70 wt. %, where wt. % is based on total resin solids.

### B. The Second Compound

The reactive composition according to the present disclosure includes a second compound that includes a functional group reactive with the carboxylic acid functional groups in the first compound. The functional group in the second compound can include, without limitation, a carbodiimide, an epoxy, a hydroxyl, a thiol, a primary amine, a secondary amine, a hydroxyl amine, an oxazoline, hydroxyalkyl amide, hydroxyalkyl urea, and/or an aziridine functional group.

The second compound can be molecular, or non-polymeric, or it can be a polymer. As such the second compound can include a base molecule and/or a polymer backbone.

The second compound can be a liquid at ambient conditions or have a melting point of at least about 30° C., such as at least about 50° C., or at least about 80° C. and can be up to about 120° C., such as up to about 110° C. or up to about 100° C. or within any range using any two of the foregoing values as endpoints, such as from 30° C. to 120° C., or from 30° C. to 110° C., or from 50° C. to 100° C.

When the second compound is non-polymeric, it can have a molecular weight of less than 2,000 g/mol, such as less than 1,500 g/mol, or less than 1,000 g/mol, or less than 750 g/mol, or less than 500 g/mol, where molecular weight is determined by summing the atomic weights of the individual atoms making up the second compound.

As nonlimiting examples, the second compound can include resorcinol diglycidyl ether, 1,3,5-triglycidyl isocyanurate, neopentyl glycol diglycidyl ether, 1,6-hexanediol diglycidyl ether, glycerol, polyglycidyl ether, hydrogenated bisphenol A diglycidyl ether, bisphenol A diglycidyl ether, trimethyl propane polyglycidyl ether, pentaerythritol polyglycidyl ether, sorbitol polyglycidyl ether, polypropylene glycol diglycidyl ether, propylene imine-based polyaziridine, trimethylolpropane tris(2-methyl-1-aziridine propionate), ethylene imine-based polyaziridine, trimethylolpropane tris(2-methyl-1-aziridine propionate, tetramethylolmethanetris (β-aziridinyl propionate), trimethylolpropane tris (β-aziridinyl propionate), 1,2-phenylene-bis-oxazoline, 1,3-phenylene-bis-oxazoline, 1,4-phenylene-bis-oxazoline, 1,2-bis(oxazolinyl-4-methyl)benzene, 1,3-bis(oxazolinyl-4-methyl)benzene, 1,4-bis(oxazolinyl-4-methyl)benzene, 1,2-bis(oxazolinyl-5-ethyl)benzene, 1,3-bis(oxazolinyl-5-methyl)benzene, 1,3-bis(oxazolinyl-5-ethyl)benzene, 1,4-bis(oxazolinyl-5-ethyl)benzene, 1,2,4-tris(oxazolinyl)benzene, 1,3,5-tris(oxazolinyl)benzene, and 1,2,4,5-tetrakis(oxazolinyl)benzene, acrylic-based oxazoline functionalized reactive copolymers, N,N′-dicyclohexylcarbodiimide, N,N′-diisopropylcarbodiimide, 1-ethyl-3-(3-dimethylaminopropyl)carbodiimide, polycarbodiimide, hydroxylalkylamides, such as those available under the trade name PRIMID from Estron Chemical, Inc., (hydroxylalkyl) ureas and/or N,N,N′N′-tetrakis(3-hydroxylethyl) adipamide.

The second compound can include, without limitation, an epoxy functional compound that includes a structure according to structure (II):

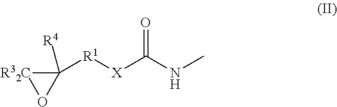

where R¹ can be a C₁ to C₆, such as a C₁ to C₄ or C₁ to C₃ linear or branched alkyl group and X can be O, S or NR², wherein R² can be H, methyl, ethyl, propyl or isopropyl; each R³ and R⁴ can independently be a H, a C₁ to C₅ linear or branched alkyl group, a base molecule containing a molecular chain of from 6 to 60, such as from 6 to 50, or from 6 to 40 linear, branched, cyclic and/or aromatic carbon atoms, and/or a polymer backbone and can optionally include a hetero atom such as O, S or NR⁵, wherein R⁵ can be H, methyl, ethyl, propyl or isopropyl, optionally wherein one R³ and R⁴ can form part of a polymer backbone and/or a base molecule that includes a molecular chain of from 6 to 60, such as from 6 to 50, or from 6 to 40 linear, branched, cyclic and/or aromatic ring units, such as carbon atoms. Each R³ and R⁴ can independently optionally include a hetero atom such as O, S or NR⁶, where R⁶ is H, methyl, ethyl, propyl or isopropyl. The epoxy functional compound can be an end group and/or pendant from the polymer backbone and/or the base molecule.

As indicate above, and not being limited to any single theory, the activity of the first compound that includes acid functional groups can be enhanced if the acid functional group is in close proximity of a urethane, urea, thiourea or thiourethane or urea group. Similarly, and not being limited to any single theory, the activity of the second compound that includes epoxy functional groups can be enhanced if the epoxy functional group is in close proximity of a urethane, urea, thiourea, or thiourethane group. When combined, it is believed that the enhanced activity allows the first and second compounds to react or cure at lower temperatures.

The second compound can include a polymer containing urethane, urea, thiourea, or thiourethane repeat groups, (meth)acrylate repeat groups, ester repeat groups, amide repeat groups, and/or carbonate repeat groups.

When the second compound includes a polymer, the polymer can have a weight average molecular weight of from greater than 2,000 g/mol to 50,000 g/mol, such as from 2,500 g/mol to 40,000 g/mol, or from 3,000 g/mol to 30,000 g/mol determined by gel permeation chromatography using polystyrene standards.

The reactive composition of the present disclosure may include an amount of the second compound of from 15 wt. %, such as from 20 wt. %, such as from 30 wt. %, such as from 40 wt. %, such as from 50 wt. %, or from 60 wt. % up to 90 wt. %, such as up to 85 wt. %, such as up to 80 wt. %, or up to 70 wt. %, or within any range using any two of the foregoing values as endpoints, such as from 15 wt. % to 90 wt. %, or from 15 wt. % to 85 wt. %, or from 20 wt. % to 80 wt. %, or from 30 wt. % to 80 wt. %, or from 30 wt. % to 70 wt. %, or from 40 wt. % to 70 wt. %, or from 50 wt. % to 80 wt. %, or from 60 wt. % to 70 wt. %, where wt. % is based on total resin solids.

The reactive composition of the present disclosure may include a mixture that includes a stoichiometric ratio of carboxylic acid groups in the first compound to functional groups reactive with the carboxylic acid functional groups in the second compound of from 1:10 to 10:1, such as from 1:7 to 7:1, or from 1:5 to 5:1, or from 1:4 to 4:1, or from 1:3 to 3:1, or from 1:2 to 2:1 or from 1.0:1.3 to 1.3:1.0.

### C. Catalyst

The reactive composition according to the present disclosure can include a catalyst. The catalyst can include zinc, a phosphine, an amine, a quaternary ammonium group, a phosphonium, and/or a quaternary phosphonium group.

When the reactive composition includes a catalyst, it can initiate a reaction between the first compound and the functional groups of the second compound or make the reaction able to proceed under a modified rate. The catalyst is not consumed by the reaction.

When the catalyst includes an amine, the amine can be a tertiary amine, such as an aromatic amine such as imidazole and/or pyridine, and/or an aliphatic amine such as diisopropyl ethyl amine, 1,4-diazabicyclo[2.2.2]octane, 1,8-diazabicyclo[5.4.0]undec-7-ene, and/or triethyl amine.

The reactive composition of the present disclosure may be derived from a reaction mixture that includes an amount of catalyst of from 0.05 wt. %, such as from 0.1 wt. %, or from 0.25 wt. % up to 2 wt. %, such as up to 1.5 wt. %, or up to 1 wt. %, or within any range using any two of the foregoing values as endpoints, such as from 0.05 wt. % to 2 wt. %, or from 0.1 wt. % to 1.5 wt. %, or from 0.25 wt. % to 1 wt. %, where wt. % is based on the weight of the reactive composition.

### III. Reaction and/or Curing

The reactive compositions described herein react and/or cure at a faster rate and/or when less energy is applied, such as at a lower temperature, than a composition that does not include a compound that includes the carboxylic acid functional groups according to structure (I) of the first compound, such as where the acid functional groups are spaced greater than 6 carbon atoms from a urethane, urea, thiourea, or thiourethane group or that do not include a urethane, urea, thiourea, or thiourethane group. When the reactive compositions described herein react and/or cure as described, they can react more completely, i.e., more or all of the carboxylic acid functional groups according to structure (I) react with the functional group reactive with the carboxylic acid functional groups in the second compound, which can lead to, as a nonlimiting example, better solvent resistance as reflected in a higher MEK double rub score when compared with compositions that do not include a compound that includes the carboxylic acid functional groups according to structure (I) of the first compound.

### A. Reactive Composition

As indicated above, the compositions described herein can include a reaction product of the first compound and the second compound of the reactive composition. As indicated, the first compound and the second compound react at a faster rate and/or at a lower temperature compared to reactive compositions that do not include a first compound containing a carboxylic acid functional group in close proximity to a urethane, urea, thiourea, or thiourethane group, as in structure (I), as described above.

The reaction product of the first compound and the second compound of the reactive composition can be a low molecular weight molecule and have a molecular weight of less than 2,000, such as less than 1,500, or less than 1,000, or less than 750, or less than 500 g/mol.

When, the reaction product of the first compound and the second compound of the reactive composition is a polymer, the polymer can have a weight average molecular weight of from greater than 2,000 to 50,000, such as from 2,500 to 40,000, or from 3,000 to 30,000 g/mol determined by gel permeation chromatography using polystyrene standards.

### B. Curable Composition

The reactive composition can be a curable composition. As a nonlimiting example, when the reactive composition is a curable composition the first compound includes at least two carboxylic acid groups as shown in structure (I) and the second compound includes at least two functional groups reactive with the carboxylic acid functional groups. As a nonlimiting example, when the reactive composition is a curable composition the first compound can include more than two carboxylic acid groups and/or the second compound can include more than two functional groups reactive with the carboxylic acid functional groups. When at least one of the first compound and second compound includes more than two carboxylic acid groups or groups reactive with the carboxylic acid functional groups, the composition can be a thermosetting composition.

### C. Physical Form of the Reactive Composition

The reactive composition can be in the form of a liquid composition or a powder composition.

i. Powder Composition

When the reactive composition is in the form of a powder, at ambient temperature, the reactive composition includes solid particulates. The powder composition can be a curable composition as described above and includes the first compound and the second compound.

When the reactive composition is a powder composition, the powder composition includes no more than 10 wt. %, such as no more than 5 wt. % or no more than 2 wt. % of a solvent and can be essentially free (less than 1 wt. %), substantially free (less than 0.1 wt. %) or completely free (undetectable by FTIR) of solvent based on the weight of the powder composition.

When the reactive composition is a powder composition, the powder composition can include oligomers and/or polymers as described above. The oligomers and/or polymers can have a glass transition temperature of from 20° C. to 100° C., such as from 30° C. to 90° C., or from 40° C. to 80° C., determined by Differential Scanning Calorimetry. When the glass transition temperature of the oligomers and/or polymers is more than the aforementioned minimum value, the powder composition can be crushed and/or ground and easily made into a powder composition.

ii. Liquid Composition

When the reactive composition is in the form of a liquid, the reactive composition can include a solvent, such as an organic solvent and/or water. The liquid composition can be a curable composition as described above and includes the first compound and the second compound.

When the reactive composition is a liquid composition, it can be free of solvents when the reactive composition is a liquid at ambient conditions. In this instance, the liquid composition is termed “solvent free”. The reactive composition can include from 30 to 80 wt. % solvent, such as from 30 to 70 wt. % solvent, or from 40 to 60 wt. % solvent based on the weight of the reactive composition, where the solvent includes water and/or organic solvent.

Suitable organic solvents that can be included in the solvent include, but are not limited to ester, ketone, glycol ether, alcohol, hydrocarbon or mixtures thereof. Suitable ester solvents can include alkyl acetates such as ethyl acetate, n-butyl acetate, n-hexyl acetate, and mixtures thereof. Suitable ketone solvents may include methyl ethyl ketone, methyl isobutyl ketone, and mixtures thereof. Suitable hydrocarbon solvents may include toluene, xylene, aromatic hydrocarbons, and aliphatic hydrocarbons such as hexane, heptanes, and nonane.

The liquid composition may include an amount of organic solvent of from 0 wt. %, such as from 10 wt. %, or from 20 wt. % and up to 60 wt. %, such as up to 50 wt. %, or up to 40 wt. % or within any range using any two of the foregoing values as endpoints, such as from 0 wt. % to 60 wt. %, or from 10 wt. % to 50 wt. %, or from 20 wt. % to 40 wt. %, where wt. % is based on a total weight of the liquid composition.

When, as a nonlimiting example, the liquid composition includes water, the liquid composition can include a neutralizing amine at a level of from 40-120%, or from 40-80%, or from 40-90% or from 60-100%, or from 80-90% total neutralization, based on the number of acid groups in the reactive composition. “Neutralizing amine” and like terms indicate an amine that may be utilized to neutralize at least some of the compound that includes acid functional groups, such as to make the compound more water soluble. Suitable neutralizing amines may include ammonia. Suitable neutralizing amines may include secondary amines, such as diethyl amine. Further, suitable neutralizing amines may include tertiary amines, such as triethyl amine, triethylamine, tributylamine, dimethylethanolamine, triethanolamine, 1, 4-diazabicyclo [2.2.2]octane, 1, 8-diazabicylco[5.4.0]undec-7-ene, tripropylamine, and diisopropylethylamine. The neutralizing amine can include, without limitation, a tertiary amine, ammonia, and combinations thereof.

The neutralizing amine can be present in an amount necessary to at least partially neutralize the acid groups in the first compound. A 100 percent neutralization means that the mole ratio of neutralizing amine to acid groups is 1:1.

### D. Additives

The reactive composition of the present disclosure may further include one or more additives. Such additives can include solvents, surfactants, surface agents, catalysts, water, colorants including pigments and/or dyes, plasticizers, antioxidants, hindered amine light stabilizers, UV light absorbers and stabilizers, surfactants, flow control agents, thixotropic agents, fillers, organic cosolvents, reactive diluents, leveling agents, defoamers, grind vehicles, and other customary auxiliaries.

### E. End Use Compositions

The reactive composition or compositions that include the reaction product derived therefrom can be in the form of a low molecular weight composition, coating composition, an adhesive composition or a sealant composition.

i. Low Molecular Weight Composition

The low molecular weight composition can be useful for, as nonlimiting examples, pharmaceutical and/or non-curable applications, where the reactive composition can be used as is or act as an intermediate allowing for the synthesis of desired or target compounds.

The low molecular weight composition can include a reaction product of the reactive compositions described herein. The low molecular weight reaction product can have a molecular weight of less than 2,000, such as less than 1,500, or less than 1,000, or less than 750, or less than 500 g/mol.

The low molecular weight composition can include a chiral center and the composition can include stereoisomers, diastereomers, and enantiomers and/or can be a racemic mixture.

ii. Adhesive

As noted above, the present disclosure provides a reactive composition suitable for use as an adhesive. When used as an adhesive, the reactive composition can be in the form of a 1K (“One-Component), 2K (“Two-Component”) or a multi component adhesive composition that can be used to bond together two substrate materials for a wide variety of potential applications in which the bond between the substrate materials provides particular mechanical properties related to elongation, tensile strength, lap shear strength, T-peel strength, modulus, or impact peel strength. When the adhesive is a 1K composition, the first compound and/or the second compound can be blocked. The adhesive can be applied to either one or both of the materials being bonded. The pieces are aligned and pressure and spacers may be added to control bond thickness. The present adhesives can be curable compositions as described above. For 2K and multi component adhesives, the compound that includes acid groups and the compound that includes groups reactive with the acid group, such as a carbodiimide, an epoxy, a hydroxyl, a thiol, a primary amine, a secondary amine, a hydroxyl amine, an oxazoline, a hydroxyalkyl amide, a hydroxyalkyl urea, and/or an aziridine functional group, are in separate components, the curing begins upon the mixing together of the components at ambient or slightly higher temperatures. By contrast for 1K adhesives, the adhesive can be cured using an external source such as an oven (or other thermal means) or through the use of actinic radiation (UV light, etc.).

Suitable substrate materials that can be bonded by the present adhesive compositions include, but are not limited to, materials such as, metals or metal alloys, natural materials such as wood, polymeric materials such as hard plastics, or composite materials.

iii. Sealant

Reactive compositions and curable compositions of the present disclosure can be advantageously used as sealants, and in particular, as sealants where low temperature (less than 20° C.) flexibility and resistance to fuel are desirable attributes.

Reactive compositions and curable compositions of the present disclosure can be prepared by combining a first component that includes the compound that includes acid groups and a second component that includes the compound that includes groups reactive with the acid group, such as a carbodiimide, an epoxy, a hydroxyl, a thiol, a primary amine, a secondary amine, a hydroxyl amine, an oxazoline, hydroxyalkyl amide, hydroxyalkyl urea, and/or an aziridine functional group containing compound. When the sealant is a 1K composition, the first compound and/or the second compound can be blocked. The first and second components can be combined in a desired ratio using, for example, meter mix equipment fitted with a dynamic mix head. Pressure from the meter mix equipment can force the first and second components through the dynamic mix head and an extrusion die. The first and second components can be combined immediately prior to application to a surface to be sealed.

Reactive compositions and curable compositions of the present disclosure can be useful as sealants for sealing metal surfaces, such as welded junctions of metal automotive panels, and/or Mil-C and/or AMS surfaces including stainless steel, aluminum, and/or Alcalad surfaces.

Reactive compositions and curable compositions of the present disclosure can be applied to a surface by any means known to those skilled in the art and as appropriate for a particular application including extruding, pressing, grouting, caulking, spreading, and the like.

Reactive compositions and curable compositions of the present disclosure can be cured according to recommended procedures as can be determined by one skilled in the art as nonlimiting examples, at ambient temperature. The reactive compositions and curable compositions can be reacted at a minimum temperature of less than 0° C., such as at a minimum temperature of −10° C., or at a minimum temperature of −20° C.

iv. Coating Composition

The reactive composition of the present disclosure may be applied as a coating composition to an article or substrate using spray coating, roller coating, coil coating, dip coating, precision coating, or spin coating techniques. The reactive composition may be deposited over at least a part of a surface of the article and cured to form a cured layer.

The coating composition can be used in a method of coating a substrate that includes applying the reactive composition over at least a part of a substrate using spray coating, roller coating, coil coating, dip coating, precision coating, or spin coating techniques and curing the reactive composition to form a cured layer.

The coating composition can be in the form of a 1K (“One-Component), 2K (“Two-Component”) or a multi component coating composition. When the coating composition is a 1K composition, the first compound and/or the second compound can be blocked.

The coating composition can include one or more layers of a multi-layer coating. As a nonlimiting example, the present coating composition can be a primer coat, a basecoat or color coat layer and/or a clear coat layer. As a nonlimiting example, the coating composition can be a primer coat and/or a topcoat.

After coating a substrate and prior to curing the reactive curable composition, it can be flashed at a temperature of from 10° C. to 80° C., such as from 20° C. to 60° C., such as from 20° C. to 40° C. for from 5 to 60 minutes, such as from 5 to 60 minutes, such as from 5 to 30 minutes.

The curable compositions of the present disclosure may be curable at a temperatures of from 0° C., such as from 20° C., or from 40° C., or from 60° C., or from 80° C., or from 100° C. and up to 120° C., such as up to 140° C., or up to 160° C., or up to 215° C., or up to 225° C., or up to 240° C., or up to 260° C., or within any range using any two of the foregoing values as endpoints, such as from 0° C. to 260° C., or from 20° C. to 240° C., or from 40° C. to 225° C., or from 60° C. to 225° C., or from 80° C. to 215° C., or from 100° C. to 215° C. The curable compositions can be cured for from 5 seconds to 48 hours, such as from 5 seconds to 24 hours, or from 10 seconds to 12 hours, or from 1 minute to 12 hours, or from 1.5 minutes to 12 hours, or from 1.75 minutes to 12 hours. Optionally, prior to curing the applied curable composition can be flashed at 10° C. to 80° C., such as from 20° C. to 60° C., such as from 20° C. to 40° C., such as ambient (20° C.) temperature to 40° C., for from 5 to 60 minutes, such as from 5 to 30 minutes.

As will be understood by one skilled in the art, the time and temperature used for curing will be adjusted according to the needs of the particular application. For example, the application can include coil coatings which can be cured for short times at high temperatures, as a nonlimiting example, for 5 to 20 seconds at 180 to 220° C. Another nonlimiting example may be an automotive application where curable compositions of the present disclosure may be cured at a temperature of from 80° C. to 140° C. for from 10 minutes to 1 hour. In a further example, such as automotive refinish or industrial applications, the curable compositions of the present disclosure may be cured at a temperature of rom 0 to 80° C. for from 5 minutes to 48 hours.

The coating composition can be a curable composition formed as described above and can exhibit increased resistance to solvents as compared to coatings derived from compositions that do not include a first compound according to structure (I) and optionally a second compound according to structure (II).

To test the resistance of a coating composition, a substrate coated with the coating composition may be subjected to a solvent resistance test as described below.

A solvent resistance test may be performed by placing a test panel on a flat table or other suitable flat, firm surface. Two sterile gauze pads may be affixed over the end of a one-pound Ball-Peen hammer. The gauze may be affixed such that it is snugly held in place with a rubber band and has four layers of gauze over the end of the hammer with no wrinkles.

The gauze is saturated with an appropriate solvent, such as methyl ethyl ketone (MEK), for the substrate being tested. The gauze is re-saturated every 25 double rubs.

The substrate coated with the curable composition is immediately rubbed with the saturated gauze over the test area using a back-and-forth stroke of 2-4 inches. The weight of the hammer controls the downward pressure.

The back-and-forth strokes may be continued, counting one “double rub” for each forward and backward motion completed until the bare substrate is exposed in the center of the strip where the rubs are performed or until 100 double rubs are achieved.

The number of “double rubs” are recorded as the test result (MEK double rubs). The gauze should be removed and replaced with new gauze in between each sample tested.

The coating composition according to the present disclosure (coatings derived from compositions that include a first compound according to structure (I) and optionally a second compound according to structure (II)) can exhibit increased resistance to solvents as indicated by MEK double rubs compared to coatings derived from compositions that do not include a first compound according to structure (I) or a second compound according to structure (II).

v. Three-Dimensional Printing

The reactive composition described herein can be used to make an article of manufacture by ambient reactive extrusion (three-dimensional printing). The article can be made using the first compound and the second compound described above.

The reactive and/or curable compositions described above can be suitable for use with ambient reactive extrusion (ARE) can be used according to the present disclosure. This broadly includes thermosetting polymers (sometimes referred to as a thermoset), thermoplastic polymers, or combinations thereof. The co-reactive components are chosen by one skilled in the art and include the first compound and the second compound in order to result in the desired curable composition from which to formulate the article.

Articles according to the present disclosure are additively manufactured by extruding the curable composition onto a surface, such as a build platform. The reactive composition may be in an at least partially reacted state at the time of extrusion and thereafter fully react and cure to form a layer of the curable composition. Successive layers of the same and/or different curable compositions can be deposited, forming additional layers of material. The combination of layers forms the article. The curable composition may be at least partially reacted when the first compound and the second compound come together, such as in a mixing volume, just prior to extrusion. Alternatively, the two co-reactive compounds can be premixed before extrusion and treated in a way to arrest the reaction between the co-reactive compounds, such as by freezing the composition after mixing.

It may be desirable to select the chemistry of each layer of the deposited curable composition such that covalent bonds between successive layers are formed. Different portions of the article can be printed from different curable compositions (e.g., a first curable composition printed to form a first portion of the object such as a base portion, an internal structure, etc., and a second curable composition printed to form a second portion of the object); depending on the chemical reactivity between the different curable compositions, covalent bonds might also form between different materials.

An article may be printed so as to have a rigid portion (unable to bend without breaking) and a flexible portion (does not break when initially bent), a rigid portion and a foam-like portion (curable composition includes voids), a tactile portion (textured) and a rigid and/or flexible portion, two or more portions that include different densities, one or more conductive portions, one or more thermally/electrically conductive (allows heat or electricity to travel through) portions, two or more different colors, two or more different rheological profiles, two or more different materials that include different affinities for water and/or solvent(s), and the like. The article may also be printed such that the curable compositions are deposited onto existing articles (e.g., other thermosets and/or thermoplastics, metals, woods, composite materials, ceramics, etc.).

Ambient manufacturing as described herein may result in an object having higher strength, particularly along the Z (e.g., vertical) axis, as compared to other extruded or printed parts due to the covalent bonding between the printed layers. Strong intralayer and interlayer covalent bonding results in not only stronger parts, but also in more uniform part geometries; that is, less print lines and/or portion differentials. The present disclosure therefore provides the ability to form, in one process, objects having multiple substrates and/or portions that include different compositions.

The article can form at least part of a vehicle, an article of manufacture, a consumer electronic device, a consumer appliance, a pavement, a road marking or a structure, such as a component of modular housing.

The reactive composition can be applied as multiple layers, where a first reactive composition can be applied as a first layer and a second reactive composition can be applied to a surface of the first reactive composition, making up a second layer. The first reactive composition and/or the second reactive composition include the first compound and the second compound.

The viscosity of the first and second reactive compositions can be from 1 cps to 1,000,000 cps, such as from 250 cps to 500,000 cps, from 300 cps to 100,000 cps or from 500 to 50,000 cps determined at 23° C. using a Brookfield Viscometer (AMETEK. Inc.) using spindle No. 7 at 50 rpm.

### ASPECTS

Aspect 1. A reactive composition that comprises:
a first compound that comprises from 1 to 12 carboxylic acid functional groups according to structure (I):

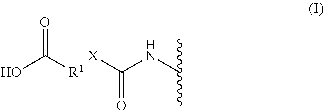

where R¹ is a C₁ to C₆, such as a C₁ to C₄ or C₁ to C₃ linear or branched alkyl group and X is O, S or NR², where R² is H, methyl, ethyl, propyl or isopropyl; and
a second compound that comprises a functional group reactive with the carboxylic acid functional groups in the first compound.

Aspect 2. A reactive composition that comprises:
a first compound that comprises from 1 to 10 carboxylic acid functional groups according to structure (I):

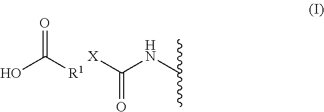

where R¹ is a C₁ to C₆, such as a C₁ to C₄ or C₁ to C₃ linear or branched alkyl group and X is O, S or NR², where R² is H, methyl, ethyl, propyl or isopropyl; and
a second compound that comprises a functional group reactive with the carboxylic acid functional groups in the first compound.

Aspect 3. A reactive composition that comprises:
a first compound that comprises from 1 to 6 carboxylic acid functional groups according to structure (I):

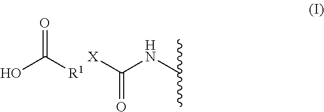

where R¹ is a C₁ to C₆, such as a C₁ to C₄ or C₁ to C₃ linear or branched alkyl group and X is O, S or NR², where R² is H, methyl, ethyl, propyl or isopropyl; and
a second compound that comprises a functional group reactive with the carboxylic acid functional groups in the first compound.

Aspect 4. A reactive composition that comprises:
a first compound that comprises from 1 to 5 carboxylic acid functional groups according to structure (I):

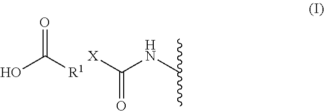

where R¹ is a C₁ to C₆, such as a C₁ to C₄ or C₁ to C₃ linear or branched alkyl group and X is O, S or NR², where R² is H, methyl, ethyl, propyl or isopropyl; and
a second compound that comprises a functional group reactive with the carboxylic acid functional groups in the first compound.

Aspect 5. A reactive composition that comprises:
a first compound that comprises from 1 to 4 carboxylic acid functional groups according to structure (I):

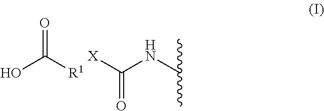

where R¹ is a C₁ to C₆, such as a C₁ to C₄ or C₁ to C₃ linear or branched alkyl group and X is O, S or NR², where R² is H, methyl, ethyl, propyl or isopropyl; and
a second compound that comprises a functional group reactive with the carboxylic acid functional groups in the first compound.

Aspect 6. The reactive composition according to any preceding aspect where R¹ is a C₁ to C₄, or C₁ to C₃ linear or branched alkyl group.

Aspect 7. The reactive composition according to any preceding aspect, where the first compound comprises a polymer backbone and/or a base molecule that comprises a molecular chain of from 6 to 60, such as from 6 to 50, or from 6 to 40 linear, branched, cyclic and/or aromatic carbon atoms and can optionally comprise a hetero atom comprising O, S or NR⁵, where R⁵ is H, methyl, ethyl, propyl or isopropyl and where the carboxylic acid functional groups are comprised as an end group and/or a pendant group from the polymer backbone and/or the base molecule.

Aspect 8. The reactive composition according to aspect 7, where the base molecule comprises a cyclic moiety containing from 5 to 14 ring units, where, optionally, some of the ring units comprise a hetero atom and the remaining ring units comprise carbon.

Aspect 9. The reactive composition according to aspect 8, where the base molecule comprises a cyclic moiety containing from 6 to 12 or 6 to 10 ring units

Aspect 10. The reactive composition according to any preceding aspect, where the first compound comprises a polymer containing a carboxylic acid group and has an acid value of from 10 mg KOH to 250 mg KOH on solids according to ASTM D 4662-15.

Aspect 11. The reactive composition according to any preceding aspect, where the first compound comprises a polymer containing a carboxylic acid group and has an acid value of from 20 mg KOH to 225 mg KOH, such as from 25 mg KOH to 200 mg KOH on solids according to ASTM D 4662-15.

Aspect 12. The reactive composition according to any preceding aspect, where the carboxylic acid functional group is the reaction product of an isocyanate and a compound containing a carboxylic acid group and a hydroxyl, a carboxylic acid group and a thiol and/or a carboxylic acid group and an amine.

Aspect 13. The reactive composition according to any preceding aspect, where the first compound comprises a reaction product of isophorone diisocyanate and mercapto propionic acid, a reaction product of isophorone diisocyanate trimer and mercapto propionic acid, a reaction product of hexamethylene diisocyanate trimer and mercapto propionic acid, a reaction product of dicyclohexylmethane diisocyanate and mercapto propionic acid, a reaction product of hexane diisocyanate and mercapto propionic acid, a reaction product of tetramethylxylylene diisocyanate and mercapto propionic acid, a reaction product of isophorone diisocyanate and hydroxypropionic acid, a reaction product of Isophorone diisocyanate trimer and hydroxypropionic acid, a reaction product of hexamethylene diisocyanate trimer and hydroxypropionic acid, a reaction product of dicyclohexylmethane diisocyanate and hydroxypropionic acid, a reaction product of hexane diisocyanate and hydroxypropionic acid, a reaction product of tetramethylxylylene diisocyanate and hydroxypropionic acid, of isophorone diisocyanate and hydroxy pivalic acid, a reaction product of isophorone diisocyanate trimer and hydroxy pivalic acid, a reaction product of dicyclohexylmethane diisocyanate and hydroxy pivalic acid, a reaction product of hexane diisocyanate and hydroxy pivalic acid, a reaction product of tetramethylxylylene diisocyanate, hydroxy pivalic acid, a reaction product of a cyclic carbonate and a carboxylic acid containing amine, a reaction product of triphenylmethane triisocyanate and mercapto propionic acid, a reaction product of toluene-2,4,6-triyl triisocyanate, and mercapto propionic acid, a reaction product of a tetraisocyanate according to the structure C(CH₂O(CH₂CH₂O)nCH₂CH₂NCO)₄, wherein n is from 1 to 20, and mercapto propionic acid, a reaction product of triphenylmethane triisocyanate and hydroxypropionic acid, a reaction product of toluene-2,4,6-triyl triisocyanate, and hydroxypropionic acid, a reaction product of a tetraisocyanate according to the structure C(CH₂O(CH₂CH₂O)nCH₂CH₂NCO)₄, wherein n is from 1 to 20, and hydroxypropionic acid, a reaction product of triphenylmethane triisocyanate and hydroxy pivalic acid, a reaction product of toluene-2,4,6-triyl triisocyanate, and hydroxy pivalic acid, and/or a reaction product of a tetraisocyanate according to the structure C(CH₂O(CH₂CH₂O)nCH₂CH₂NCO)₄, wherein n is from 1 to 20, and hydroxy pivalic acid.

Aspect 14. The reactive composition according to any preceding aspect, where the first compound comprises a polymer containing urethane repeat groups, urea repeat groups, thiourea repeat groups, thiourethane repeat groups, (meth)acrylate repeat groups, ester repeat groups, amide repeat groups, and/or carbonate repeat groups.

Aspect 15. The reactive composition according to any preceding aspect, where the first compound is present at from 10 wt. % to 85 wt. %, where wt. % is based on total resin solids.

Aspect 16. The reactive composition according to any preceding aspect, where the first compound is present at from 15 wt. % to 85 wt. %, such as from 20 wt. % to 80 wt. %, or from 30 wt. % to 80 wt. %, or from 30 wt. % to 70 wt. %, or from 40 wt. % to 70 wt. %, or from 50 wt. % to 80 wt. %, or from 60 wt. % to 70 wt. %, where wt. % is based on total resin solids.

Aspect 17. The reactive composition according to any preceding aspect, where the second compound comprises a carbodiimide, an epoxy, a hydroxyl, a thiol, a primary amine, a secondary amine, a hydroxyl amine, an oxazoline, hydroxyalkyl amide, hydroxyalkyl urea, and/or an aziridine functional group.

Aspect 18. The reactive composition according to any preceding aspect, where the second compound comprises resorcinol diglycidyl ether, 1,3,5-triglycidyl isocyanurate, neopentyl glycol diglycidyl ether, 1,6-hexanediol diglycidyl ether, glycerol, polyglycidyl ether, hydrogenated bisphenol A diglycidyl ether, bisphenol A diglycidyl ether, trimethyl propane polyglycidyl ether, pentaerythritol polyglycidyl ether, sorbitol polyglycidyl ether, polypropylene glycol diglycidyl ether, propylene imine-based polyaziridine, trimethylolpropane tris(2-methyl-1-aziridine propionate), ethylene imine-based polyaziridine, trimethylolpropane tris(2-methyl-1-aziridine propionate, tetramethylolmethanetris (β-aziridinyl propionate), trimethylolpropane tris (β-aziridinyl propionate), 1,2-phenylene-bis-oxazoline, 1,3-phenylene-bis-oxazoline, 1,4-phenylene-bis-oxazoline, 1,2-bis(oxazolinyl-4-methyl)benzene, 1,3-bis(oxazolinyl-4-methyl)benzene, 1,4-bis(oxazolinyl-4-methyl)benzene, 1,2-bis(oxazolinyl-5-ethyl)benzene, 1,3-bis(oxazolinyl-5-methyl)benzene, 1,3-bis(oxazolinyl-5-ethyl)benzene, 1,4-bis(oxazolinyl-5-ethyl)benzene, 1,2,4-tris(oxazolinyl)benzene, 1,3,5-tris(oxazolinyl)benzene, and 1,2,4,5-tetrakis(oxazolinyl)benzene, acrylic-based oxazoline functionalized reactive copolymers, N,N′-dicyclohexylcarbodiimide, N,N′-diisopropylcarbodiimide, 1-Ethyl-3-(3-dimethylaminopropyl)carbodiimide, polycarbodiimide, hydroxylalkylamides, (hydroxylalkyl) ureas, and/or N,N,N′N′-tetrakis(3-hydroxylethyl) adipamide.

Aspect 19. The reactive composition according to any preceding aspect, wherein the second compound comprises an epoxy functional compound that comprises a structure according to structure (II):

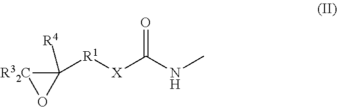

where R¹ is a C₁ to C₆ linear or branched alkyl group and X is O, S or NR², wherein R² is H, methyl, ethyl, propyl or isopropyl;
where each R³ and R⁴ can independently be a H, a C₁ to C₅ linear or branched alkyl group, a base molecule comprising a molecular chain of from 6 to 60 linear, branched, cyclic and/or aromatic carbon atoms, and/or a polymer backbone and can optionally comprise a hetero atom comprising O, S or NR⁵, wherein R⁵ is H, methyl, ethyl, propyl or isopropyl, optionally wherein one R³ and R⁴ can form part of a polymer backbone and/or a base molecule comprising a molecular chain of from 6 to 60 linear, branched, cyclic and/or aromatic carbon atoms, and
where each R³ and R⁴ can independently optionally comprise a hetero atom comprising O, S or NR⁶, wherein R⁶ is H, methyl, ethyl, propyl or isopropyl; and
where the epoxy functional compound is comprised as an end group and/or a pendant group from the polymer backbone and/or the base molecule.

Aspect 20. The reactive composition according to Aspect 19, where R¹ is a C₁ to C₄, such as a C₁ to C₃ linear or branched alkyl group.

Aspect 21. The reactive composition according to Aspect 19, where the base molecule of each R³ and R⁴ comprises a molecular chain of from 6 to 50, such as from 6 to 40 linear, branched, cyclic and/or aromatic carbon atoms.

Aspect 22. The reactive composition according to Aspect 19, where the optional one R³ and R⁴ form a base molecule comprising a molecular chain of from 6 to 50, such as from 6 to 40 linear, branched, cyclic and/or aromatic carbon atoms,

Aspect 23. The reactive composition according to any preceding aspect, where the second compound comprises a polymer containing urethane repeat groups, urea repeat groups, thiourea repeat groups, thiourethane repeat groups, (meth)acrylate repeat groups, ester repeat groups, amide repeat groups, and/or carbonate repeat groups.

Aspect 24. The reactive composition according to any preceding aspect, where the second compound is present at from 15 wt. % to 90 wt. %, where wt. % is based on total resin solids.

Aspect 25. The reactive composition according to any preceding aspect, where the second compound is present at from 15 wt. % to 85 wt. %, such as from 20 wt. % to 80 wt. %, or from 30 wt. % to 80 wt. %, or from 30 wt. % to 70 wt. %, or from 40 wt. % to 70 wt. %, or from 50 wt. % to 80 wt. %, or from 60 wt. % to 70 wt. %, where wt. % is based on total resin solids.

Aspect 26. The reactive composition according to any preceding aspect further comprising a catalyst.

Aspect 27. The reactive composition according to aspect 26, where the catalyst comprises zinc, a phosphine, an amine, a quaternary ammonium group, a phosphonium, and/or a quaternary phosphonium group.

Aspect 28. The reactive composition according to aspect 27, where the amine is a tertiary amine, such as an aromatic amine such as imidazole and/or pyridine, and/or an aliphatic amine such as diisopropyl ethyl amine, 1,8-diazabicyclo[5.4.0]undec-7-ene, 1,4-diazabicyclo[2.2.2]octane and/or triethyl amine.

Aspect 29. The reactive composition according to any of aspects 18 through 20, comprising an amount of catalyst of from 0.05 wt. % to 2 wt. %, where wt. % is based on the weight of the reactive composition.

Aspect 30. The reactive composition according to any of aspects 18 through 20, comprising an amount of catalyst of from 0.1 wt. % to 1.5 wt. %, such as from 0.25 wt. % to 1 wt. %, where wt. % is based on the weight of the reactive composition.

Aspect 31. The reactive composition according to any preceding aspect, where the first compound comprises at least two carboxylic acid groups and the second compound comprises at least two functional groups reactive with the carboxylic acid functional groups.

Aspect 32. The reactive composition according to any preceding aspect, where the reactive composition is a curable composition.

Aspect 33. The reactive composition according to any preceding aspect, where the reactive composition is a curable composition, and where the first compound comprises more than two carboxylic acid groups and/or the second compound comprises more than two functional groups reactive with the carboxylic acid functional groups.

Aspect 34. The reactive composition according to any preceding aspect in the form of a powder composition.

Aspect 35. The reactive composition according to any preceding aspect in the form of a liquid composition.

Aspect 36. The reactive composition according to any preceding aspect in the form of a one-component composition or a multi-component composition, such as a two-component composition, where the first compound is in one component and the second compound is in a different component.

Aspect 37. The reactive composition according to aspect 36, where the first component and/or the second component are blocked.

Aspect 38. The reactive composition according to any of aspects 35 through 37, where the liquid composition is a liquid at ambient conditions and is solvent free or the liquid composition comprises from 20 to 80 wt. % solvent, such as from 30 to 70 wt. % solvent, or from 40 to 60 wt. % solvent based on the weight of the reactive composition, where the solvent comprises water and/or organic solvent.

Aspect 39. The reactive composition according to any of aspects 35 through 38, where the liquid composition comprises from 30 to 70 wt. % solvent, such as from 40 to 60 wt. % solvent based on the weight of the reactive composition, where the solvent comprises water and/or organic solvent.

Aspect 40. The reactive composition according to any of aspects 35 through 39, further comprising a neutralizing amine at a level of from 40-120% total neutralization, based on the number of acid groups in the reactive composition.

Aspect 41. The reactive composition according to any of aspects 35 through 40, further comprising a neutralizing amine at a level of from 40-80%, such as from 40-90% or from 60-100%, or from 80-90% total neutralization, based on the number of acid groups in the reactive composition.

Aspect 42. The reactive composition according to either aspect 40 or aspect 41, where the neutralizing amine comprises a tertiary amine, ammonia, and combinations thereof.

Aspect 43. The reactive composition according to any preceding aspect in the form of a coating composition, an adhesive composition or a sealant composition.

Aspect 44. The reactive composition according to any preceding aspect where a stoichiometric ratio of carboxylic acid groups in the first compound to functional groups reactive with the carboxylic acid groups in the second compound is from 1:10 to 10:1.

Aspect 45. The reactive composition according to any preceding aspect where a stoichiometric ratio of carboxylic acid groups in the first compound to functional groups reactive with the carboxylic acid groups in the second compound is from 1:7 to 7:1, such as from 1:5 to 5:1, or from 1:4 to 4:1, or from 1:3 to 3:1, or from 1:2 to 2:1 or from 1.0:1.3 to 1.3:1.0.

Aspect 46. A composition that comprises a reaction product of the reactive composition according to any preceding aspect.

Aspect 47. The composition according to aspect 46, where the reaction product has a molecular weight of less than 2,000 g/mol.

Aspect 48. The composition according to aspect 46, where the reaction product has a molecular weight of less than 1,500, such as less than 1,000, or less than 750, or less than 500 g/mol.

Aspect 49. The composition according to any of aspects 46 through 48, where the reaction product comprises a chiral center, a stereoisomer, an enantiomer, and/or diastereomer.

Aspect 50. The composition according to any of aspects 46 through 49, where the composition is a racemic mixture.

Aspect 51. The composition according to Aspect 46, where the reaction product is a polymer having a weight average molecular weight of from 2,000 to 50,000 g/mol determined by gel permeation chromatography using polystyrene standards.

Aspect 52. The composition according to Aspect 46, where the reaction product is a polymer having a weight average molecular weight of from 2,500 to 40,000, such as from 3,000 to 30,000 g/mol determined by gel permeation chromatography using polystyrene standards.

Aspect 53. A method of coating a substrate that comprises applying the reactive composition of any one of aspects 1-45 over at least a part of a substrate using spray coating, roller coating, coil coating, dip coating, precision coating, or spin coating techniques and curing the reactive composition to form a cured layer.

Aspect 54. The method according to aspect 53, where the cured layer is part of a multi-layer coating, where the cured layer comprises a primer coat, a basecoat or color coat layer and/or a clear coat layer.

Aspect 55. The method according to either of aspects 53 or 54, where the reactive composition is reacted at a temperatures of from 0° C. to 260° C. for from 5 seconds to 168 hours.

Aspect 56. The method according to either of aspects 53 or 54, where the reactive composition is reacted at a temperatures of from 20° C. to 240° C., such as from 40° C. to 225° C., or from 60° C. to 225° C., or from 80° C. to 215° C., or from 100° C. to 215° C. for from 5 seconds to 48 hours, such as from 5 minutes to 24 hours, or from 10 minutes to 12 hours, or from 10 minutes to 12 hours, or from 20 minutes to 12 hours, or from 15 minutes to 12 hours.

Aspect 57. The method according to any of aspects 53 through 56, where prior to reacting the reactive composition, it is flashed at a temperature of from 10° C. to 80° C. for from 5 to 60 minutes.

Aspect 58. The method according to any of aspects 53 through 56, where prior to reacting the reactive composition, it is flashed at a temperature of from 20° C. to 60° C., such as from 20° C. to 40° C. for from 5 to 30 minutes.

Aspect 59. The method according to any of aspects 53 through 58, where the reactive composition reacts when less energy is applied, such as at a lower temperature, than a composition that does not comprise a compound that comprises the carboxylic acid functional groups according to structure (I).

Aspect 60. The method according to any of aspects 53 through 59, where the reactive composition reacts faster, at the same temperature, than a composition that does not comprise a compound that comprises the carboxylic acid functional group according to structure (I).

Aspect 61. The method according to any of aspects 53 through 60, where the reactive composition comprises a first compound that comprises structure (I) and a second compound that comprises structure (II) and reacts when less energy is applied, such as at a lower temperature, than a composition that either does not comprise a compound that comprises the carboxylic acid functional group according to structure (I) or comprises a compound that comprises the carboxylic acid functional group according to structure (I) but not a second compound that comprises structure (II).

Aspect 62. The method according to any of aspects 53 through 61, where the reactive composition comprises a first compound that comprises the carboxylic acid functional group according to structure (I) and a second compound that comprises structure (II) reacts faster, at the same temperature, than a composition that does not comprise a compound that comprises the carboxylic acid functional groups according to structure (I) or comprises a compound that comprises the carboxylic acid functional group according to structure (I) but not a second compound comprising structure (II).

Aspect 63. A method of making the composition according to any of aspects 53 through 61 that comprises reacting the reactive composition at a temperatures of from 0° C. to 260° C., for from 5 seconds to 48 hours, to provide the reaction product.

Aspect 64. A method of making the composition according to any of aspects 53 through 61 that comprises reacting the reactive composition at a temperatures of 20° C. to 240° C., such as from 40° C. to 225° C., or from 60° C. to 225° C., or from 80° C. to 215° C., or from 100° C. to 215° C. for from 5 minutes to 24 hours, such as from 10 minutes to 12 hours, or from 10 minutes to 12 hours, or from 20 minutes to 12 hours, or from 15 minutes to 12 hours to provide the reaction product.

Aspect 65. An article that comprises the reactive composition of any of aspects 1 through 45 deposited over at least a part of a surface of an article.

Aspect 66. An article of manufacture made by ambient reactive extrusion using the reactive composition according to any of aspects 1 through 45.

Aspect 67. The article according to aspect 66, where the article forms at least part of a vehicle, an article of manufacture, a consumer electronic device, a consumer appliance, a pavement, a road marking or a structure, such as a component of modular housing.

Aspect 68. The article according to either of aspects 66 or 67, where the reactive composition is applied as multiple layers, where a first reactive composition is applied as a first layer; and where a second reactive composition is applied to a surface of the first reactive composition, making up a second layer.

Aspect 69. The article according to any of aspects 66 through 68, where the viscosity of the first and second reactive compositions is from 1 cps to 1,000,000 cps, determined at 23° C.

Aspect 70. The article according to any of aspects 66 through 68, where the viscosity of the first and second reactive compositions is from 250 cps to 500,000 cps, such as from 300 cps to 100,000 cps or from 500 to 50,000 cps determined at 23° C.

Aspect 71. A method of improving the reactivity of a carboxylic acid functional group with a group that is reactive with the carboxylic acid functional group, the method comprising:
reacting a first compound according to structure (I) in aspect 1,
with a second compound that comprises a functional group reactive with the carboxylic acid functional group in the first compound;
where the rate of reaction of the first compound and the second compound is higher when the first compound comprises a carboxylic acid functional group according to structure (I) compared with the rate of reaction when first compound does not comprise a carboxylic acid functional group according to structure (I) where the acid functional groups are spaced greater than 6 carbon atoms from a urethane, urea, thiourea, or thiourethane group or that do not include a urethane, urea, thiourea, or thiourethane group.

Aspect 72. A method of improving the reactivity of a carboxylic acid functional group with a group that is reactive with the carboxylic acid functional group, the method comprising:
reacting a first compound according to structure (I) in aspect 2,
with a second compound that comprises a functional group reactive with the carboxylic acid functional group in the first compound;
where the rate of reaction of the first compound and the second compound is higher when the first compound comprises a carboxylic acid functional group according to structure (I) compared with the rate of reaction when first compound does not comprise a carboxylic acid functional group according to structure (I) where the acid functional groups are spaced greater than 6 carbon atoms from a urethane, urea, thiourea, or thiourethane group or that do not include a urethane, urea, thiourea, or thiourethane group.

Aspect 73. A method of improving the reactivity of a carboxylic acid functional group with a group that is reactive with the carboxylic acid functional group, the method comprising:
reacting a first compound according to structure (I) in aspect 3,
with a second compound that comprises a functional group reactive with the carboxylic acid functional group in the first compound;
where the rate of reaction of the first compound and the second compound is higher when the first compound comprises a carboxylic acid functional group according to structure (I) compared with the rate of reaction when first compound does not comprise a carboxylic acid functional group according to structure (I) where the acid functional groups are spaced greater than 6 carbon atoms from a urethane, urea, thiourea, or thiourethane group or that do not include a urethane, urea, thiourea, or thiourethane group.

Aspect 74. A method of improving the reactivity of a carboxylic acid functional group with a group that is reactive with the carboxylic acid functional group, the method comprising:
reacting a first compound according to structure (I) in aspect 4,
with a second compound that comprises a functional group reactive with the carboxylic acid functional group in the first compound;
where the rate of reaction of the first compound and the second compound is higher when the first compound comprises a carboxylic acid functional group according to structure (I) compared with the rate of reaction when first compound does not comprise a carboxylic acid functional group according to structure (I) where the acid functional groups are spaced greater than 6 carbon atoms from a urethane, urea, thiourea, or thiourethane group or that do not include a urethane, urea, thiourea, or thiourethane group.

Aspect 75. A method of improving the reactivity of a carboxylic acid functional group with a group that is reactive with the carboxylic acid functional group, the method comprising:
reacting a first compound according to structure (I) in aspect 5,
with a second compound that comprises a functional group reactive with the carboxylic acid functional group in the first compound.
where the rate of reaction of the first compound and the second compound is higher when the first compound comprises a carboxylic acid functional group according to structure (I) compared with the rate of reaction when first compound does not comprise a carboxylic acid functional group according to structure (I) where the acid functional groups are spaced greater than 6 carbon atoms from a urethane, urea, thiourea, or thiourethane group or that do not include a urethane, urea, thiourea, or thiourethane group;
where the rate of reaction of the first compound and the second compound is higher when the first compound comprises a carboxylic acid functional group according to structure (I) compared with the rate of reaction when first compound does not comprise a carboxylic acid functional group according to structure (I) where the acid functional groups are spaced greater than 6 carbon atoms from a urethane, urea, thiourea, or thiourethane group or that do not include a urethane, urea, thiourea, or thiourethane group.

Aspect 76. The method according to any of aspects 71 through 75, where the first compound comprises a carboxylic acid functional group according to structure (I), and the second compound comprises an epoxy functional group according to structure (II) in aspect 19;

where the rate of reaction of the first compound and the second compound is higher when the first compound comprises a carboxylic acid functional group according to structure (I) and the second compound comprises an epoxy functional group according to structure (II), compared with the rate of reaction when first compound does not comprise a carboxylic acid functional group according to structure (I) where the acid functional groups are spaced greater than 6 carbon atoms from a urethane, urea, thiourea, or thiourethane group or that do not include a urethane, urea, thiourea, or thiourethane group, or the second compound does not comprise an epoxy functional group according to structure (II) where the epoxy functional groups are spaced greater than 6 carbon atoms from a urethane, urea, thiourea, or thiourethane group or that do not include a urethane, urea, thiourea, or thiourethane group, and/or where both the first compound does not comprise a carboxylic acid functional group according to structure (I) and the second compound does not comprise an epoxy functional group according to structure (II).

Aspect 77. A method of improving the completeness of reacting a first compound having carboxylic acid functional groups with a second compound having functional group reactive with the carboxylic acid functional groups, where the first compound comprises carboxylic acid functional groups according to structure (I), and where more or all of the carboxylic acid functional groups according to structure (I) react with the functional group reactive with the carboxylic acid functional groups in the second compound compared to using a compound that does not comprise carboxylic acid functional groups according to structure (I).

Aspect 78. A method of improving the solvent resistance of a coating layer derived from a first compound that comprises carboxylic acid functional groups and a second compound that comprises functional groups reactive with the carboxylic acid functional groups, where a coating derived from a first compound that comprises carboxylic acid functional groups according to structure (I) provides a better solvent resistance as reflected in a higher MEK double rub score than a coating derived from a first compound that comprises carboxylic acid functional groups that do not comprise a structure according to structure (I).

### Examples

Aspects of the present disclosure are further illustrated by reference to the following examples. It will be apparent to those skilled in the art that many modifications, both to materials, and methods, may be practiced without departing from the scope of the disclosure.

### Example 1: Preparation of Acid Polyurethane According to this Disclosure

An acid polyurethane, PU-1, was prepared according to the formulation of Table 1.

To a four necked reaction flask outfitted with a stirrer, gas inlet, thermometer and condenser was added the contents of Charge 1. After the exotherm subsided, the temperature was raised to 75° C. and held for 4 hours. The NCO equivalent weight was measured according to ASTM D2572-19 (1331 g/eq, theory 1290 g/eq). The reaction was cooled to 65° C. Charge 2 was added and reaction was allowed to exotherm. Once the exotherm subsided the reaction was held at 75° C. until the NCO was undetectable as measured by transmission Fourier Transform Infrared (FTIR) spectroscopy. Charge 3 was added resulting in a final polyurethane with a measured solids content of 49.8 wt. % and a measured acid value of 107 mg KOH/g on resin solids.

TABLE 1
Acid Polyurethane PU-1

| Charge | Raw Material | Amount (g) |
|---|---|---|
| 1 | PolyTHF ® 650¹ | 260.0 |
| | Dimethylol Propionic Acid | 107.2 |
| | Isophorone Diisocyanate | 355.2 |
| | Dibutyltin Dilaurate | 0.36 |
| | Methyl Ethyl Ketone | 309.6 |
| 2 | Hydroxypivalic acid | 91.5 |
| | Methyl Ethyl Ketone | 39.7 |
| 3 | Methyl Ethyl Ketone | 465.3 |

¹Available from BASF

### Example 2: Preparation of Acid Polyurethane According to this Disclosure PU-2

An acid polyurethane, PU-2, was prepared according to the formulation of Table 2.

To a four necked reaction flask outfitted with a stirrer, gas inlet, thermometer and condenser was added the contents of Charge 1 and heated to 55° C. Charge 2 was fed in over 1 hour keeping the exotherm under 75° C. The reaction was held at 75° C. until the NCO was undetectable as measured by transmission Fourier Transform Infrared (FTIR) spectroscopy. The volatile content was removed under vacuum distillation resulting in a final polyurethane with a measured acid value of 154 mg KOH/g.

TABLE 2
Acid Polyurethane PU-2

| Charge | Raw Material | Amount (g) |
|---|---|---|
| 1 | Desmodur ® N 3300 A² | 193.0 |
| | Triethyl amine | 0.15 |
| | Methyl Ethyl Ketone | 355.2 |
| 2 | 3-mercaptopropionic acid | 106.1 |

²Aliphatic polyisocyanate available from Covestro AG

### Example 3: Preparation of Acid Polyurethane According to this Disclosure PU-3 24

An acid polyurethane, PU-3, was prepared according to the formulation of Table 3.

To a four necked reaction flask outfitted with a stirrer, gas inlet, thermometer and condenser was added the contents of Charge 1 and heated to 70° C. Charge 2 was fed in over 45 minutes keeping the exotherm under 75° C. The reaction was held at 80° C. until the NCO was undetectable as measured by transmission Fourier Transform Infrared (FTIR) spectroscopy. The volatile content was removed under vacuum distillation resulting in a final polyurethane with a measured acid value of 187 mg KOH/g.

TABLE 3
Acid Polyurethane according to this disclosure PU-3

| Charge | Raw Material | Amount (g) |
|---|---|---|
| 1 | Isophorone Diisocyanate | 155.4 |
| | Triethyl amine | 0.03 |
| | Methyl Ethyl Ketone | 288.7 |
| 2 | 3-mercaptopropionic acid | 148.4 |
| | Methyl Ethyl Ketone | 15.2 |

### Example 4: Preparation of Comparative Acid Polyester PE-1

An acid polyester, PE-1, was prepared according to the formulation of Table 4.

To a four necked reaction flask outfitted with a stirrer, gas inlet, thermometer and condenser was added the contents of Charge 1 and 2 were added. The reaction was heated to 100° C. and held for 30 minutes. Then the temperature was raised to 140° C. and held at 140° C. until the anhydride was undetectable as measured by transmission Fourier Transform Infrared (FTIR) spectroscopy. The final polyester had a measured acid value of 258 mg KOH/g.

TABLE 4
Comparative Acid Polyurethane PE-1

| Charge | Raw Material | Amount (g) |
|---|---|---|
| 1 | Methylhexahydrophthalic Anhydride | 168.2 |
| 2 | Di(trimethyolpropane) | 62.6 |

### Example 5: Preparation of Epoxy Polyurethane PU-4

An epoxy polyurethane, PU-4, was prepared according to the formulation of Table 5.

To a four necked reaction flask outfitted with a stirrer, gas inlet, thermometer and condenser was added the contents of Charge 1 and heated to 80° C. Charge 2 was fed keeping the exotherm under 90° C. The reaction was held at 90° C. until the NCO was undetectable as measured by transmission Fourier Transform Infrared (FTIR) spectroscopy. The final polyurethane had a measured solid content of 43.6 wt. % and a measured epoxy equivalent weight of 339 g/eq on resin solids.

TABLE 5
Epoxy Polyurethane PU-4

| Charge | Raw Material | Amount (g) |
|---|---|---|
| 1 | Vestanat ® T 1890/100³ | 112.5 |
| | Dibutyltin Dilaurate | 0.07 |
| | Methyl Isobutyl Ketone | 137.5 |
| 2 | Oxiranylmethanol | 37.0 |
| | Methyl Isobutyl Ketone | 86.7 |

³Available from Evonik Industries, cycloaliphatic polyisocyanate based on isophorone diisocyanate, comprises an isocyanurate ring and an NCO-functionality of 3-4

### Example 6: Preparation of Acid Polyurethane Dispersion According to this Disclosure PUD-1

A polyurethane dispersion (PUD-1) was prepared according to the formulation of Table 6.

To a four necked reaction flask outfitted with a stirrer, gas inlet, thermometer and condenser was added the contents of Charge 1. After the exotherm subsided, the temperature was raised to 80° C. and held for 3 hours. The NCO equivalent weight was measured (1286 g/eq, theory 1290 g/eq). The reaction was cooled to 50° C. Charge 2 was added and reaction was allowed to exotherm. Once the exotherm subsided the reaction was held at 65° C. until the NCO level was undetectable as measured by Fourier Transform Infrared (FTIR) Spectroscopy. Charge 3 was added. The reaction was heated to 80° C. and held until the cyclic anhydride was undetectable via FTIR. An aqueous dispersion was produced by adding Charge 4 and Charge 5. The final dispersion had a measured solids content of 37.7 wt. %, measured acid value of 87 mg KOH/g on resins solids.

TABLE 6
Polyurethane Dispersion PUD-1

| Charge | Raw Material | Amount (g) |
|---|---|---|
| 1 | PolyTHF ® 650¹ | 325.0 |
| | Dimethylol Propionic Acid | 134.0 |
| | Isophorone Diisocyanate | 444.0 |
| | Dibutyltin Dilaurate | 0.45 |
| | Methyl Ethyl Ketone | 387.2 |
| 2 | Diethanol Amine | 105.4 |
| | Methyl Ethyl Ketone | 45.0 |
| 3 | Methylhexahydrophthalic Anhydride | 168.8 |
| | Methyl Ethyl Ketone | 71.9 |
| 4 | Triethyl Amine | 143.7 |
| 5 | Deionized Water | 1538.1 |

¹Available from BASF

### Example 7: Preparation of Acid Polyurethane Dispersion According to this Disclosure PUD-2

A polyurethane dispersion (PUD-2) was prepared according to the formulation of Table 7.

To a four necked reaction flask outfitted with a stirrer, gas inlet, thermometer and condenser was added the contents of Charge 1 and was heated to 50° C. allowing the reaction to exotherm. After the exotherm subsided the reaction was held at 75° C. for one hour. The NCO equivalent weight was measured (theory 1268 g/eq, measured 1391 g/eq). The reaction was cooled to 50° C. by the assistance of adding Charge 2. Charge 3 was added followed by Charge 4 letting the reaction exotherm. Once the exotherm had subsided, the reaction was held at 60° C. until NCO was undetectable as measured by FTIR. Charge 5 was added and the reaction was held at 80° C. until the anhydride peak did not change as measured by FTIR. The final polyurethane had a measured solids content of 74.2 wt. % and a measured acid value of 93.3 mg/KOH on resin solids.

TABLE 7
Polyurethane Dispersion PUD-2

| Charge | Raw Material | Amount (g) |
|---|---|---|
| 1 | PolyTHF ® 650¹ | 63.2 |
| | 1,6-hexandiol | 22.9 |
| | Isophorone Diisocyanate | 86.3 |
| | Dibutyltin Dilaurate | 0.09 |
| | Methyl Ethyl Ketone | 7.9 |
| 2 | Methyl Ethyl Ketone | 98.4 |
| 3 | Diethanol Amine | 18.6 |
| 4 | Methyl Ethyl Ketone | 18.7 |
| 5 | Succinic Anhydride | 39.0 |
| | Methyl Ethyl Ketone | 46.6 |

¹Available from BASF

### Example 8: Preparation of Acid Polyurethane Dispersion According to this Disclosure PUD-3

A polyurethane dispersion (PUD-3) was prepared according to the formulation of Table 8.

To a four necked reaction flask outfitted with a stirrer, gas inlet, thermometer and condenser was added the contents of Charge 1. After the exotherm subsided, the temperature was raised to 80° C. and held for 3 hours. The NCO equivalent weight was measured (1831 g/eq, theory 1799 g/eq). The reaction was cooled to 50° C. Charge 2 was added and reaction was allowed to exotherm. Once the exotherm subsided the reaction was held at 65° C. until the NCO was undetectable as measured by FTIR. Charge 3 was added. An aqueous dispersion was produced by adding Charge 4. The final dispersion had a measured solids content of 38.1 wt. %, and a measured acid value of 75 mg KOH/g on resins solids.

TABLE 8
Polyurethane Dispersion PUD-3

| Charge | Raw Material | Amount (g) |
|---|---|---|
| 1 | PolyTHF ® 650¹ | 130.0 |
| | Dimethylol Propionic Acid | 107.2 |
| | Isophorone Diisocyanate | 266.4 |
| | Dibutyltin Dilaurate | 0.25 |
| | Methyl Ethyl Ketone | 215.8 |
| 2 | Diethanol Amine | 41.3 |
| | Methyl Ethyl Ketone | 17.8 |
| 3 | Triethyl Amine | 56.6 |
| 4 | Deionized Water | 722.0 |

¹Available from BASF

### Example 9: Preparation of Polyurethane Dispersion According to this Disclosure PUD-4

A polyurethane dispersion (PUD-4) was prepared according to the formulation of Table 9.

To a four necked reaction flask outfitted with a stirrer, gas inlet, thermometer and condenser was added the contents of Charge 1 and was heated to 50° C. allowing the reaction to exotherm. After exotherm subsided the reaction was held at 75° C. for six hours. The NCO equivalent weight was measured (theory 1799 g/eq, measured 1959 g/eq). The reaction was cooled to 50° C. by the assistance of adding Charge 2. Charge 3 was added followed by Charge 4 letting the reaction exotherm. Once the exotherm had subsided, the reaction was held at 65° C. until NCO was undetectable as measured by FTIR. The final polyurethane had a measured solids content of 56.0 wt. % and a measured acid value of 78.1 mg/KOH on resin solids.

TABLE 9
Polyurethane Dispersion PUD-4

| Charge | Raw Material | Amount (g) |
|---|---|---|
| 1 | PolyTHF ® 650¹ | 65.0 |
| | Dimethylol Propionic Acid | 53.6 |
| | Isophorone Diisocyanate | 133.2 |
| | Dibutyltin Dilaurate | 0.13 |
| | Methyl Ethyl Ketone | 110.0 |
| 2 | Methyl Ethyl Ketone | 128.7 |
| 3 | Dibutyl Amine | 22.7 |
| 4 | Methyl Ethyl Ketone | 37.8 |

¹Available from BASF

### Example 10: Preparation of Polyurethane Dispersion According to this Disclosure PUD-5

A polyurethane was prepared according to the formulation of Table 5.

To a four necked reaction flask outfitted with a stirrer, gas inlet, thermometer and condenser was added the contents of Charge 1. After the exotherm subsided, the temperature was raised to 80° C. and held for 5 hours. The NCO equivalent weight was measured (1350 g/eq, theory 1290 g/eq). Charge 2 was added and reaction was held the reaction was held at 80° C. until the NCO was undetectable as measured by FTIR. An aqueous dispersion was produced by adding Charge 3 and Charge 4. The final dispersion had a measured solids content of 38.9 wt. % and a theoretical acid value of 108 mg KOH/g on resin solids.

TABLE 10
Polyurethane Dispersion PUD-5

| Charge | Raw Material | Amount (g) | Wt. % |
|---|---|---|---|
| 1 | PolyTHF ® 650¹ | 130.0 | 11.22 |
| | Dimethylol Propionic Acid | 53.6 | 4.63 |
| | Isophorone Diisocyanate | 177.6 | 15.34 |
| | Dibutyltin Dilaurate | 0.18 | 0.02 |
| | Methyl Ethyl Ketone | 154.8 | 13.37 |
| 2 | Hydroxy Pivalic Acid | 45.1 | 3.89 |
| | Methyl Ethyl Ketone | 19.4 | 1.68 |
| 3 | Triethyl Amine | 55.32 | 4.78 |
| 4 | Deionized Water | 522 | 45.07 |

¹Available from BASF

### Example 11: Preparation of Polyurethane Dispersion According to this Disclosure PUD-6

A polyurethane dispersion (PUD-6) was prepared according to the formulation of Table 11.

To a four necked reaction flask outfitted with a stirrer, gas inlet, thermometer and condenser was added the contents of Charge 1. After the exotherm subsided, the temperature was raised to 75° C. and held for 5 hours. The NCO equivalent weight was measured (1312 g/eq, theory 1290 g/eq). The reaction was cooled to 65° C. Charge 2 was added followed by Charge 3. The reaction was held at 75° C. until the NCO was undetectable as measured by IR. An aqueous dispersion was produced by adding Charge 4 and Charge 5. The final dispersion had a measured solids content of 44.3 wt. % and a theoretical acid value of 101 mg KOH/g on resin solids.

TABLE 11
Polyurethane Dispersion PUD-6

| Charge | Raw Material | Amount (g) |
|---|---|---|
| 1 | PolyTHF ® 650¹ | 97.5 |
| | Dimethylol Propionic Acid | 40.2 |
| | Isophorone Diisocyanate | 133.2 |
| | Dibutyltin Dilaurate | 0.135 |
| | Methyl Ethyl Ketone | 116.1 |
| 2 | 3 Mercaptopropionic Acid | 31.3 |
| | Methyl Ethyl Ketone | 13.7 |
| 3 | Triethyl Amine | 0.61 |
| 4 | Triethyl Amine | 41.4 |
| 5 | Deionized Water | 281.6 |

¹Available from BASF

### Example 12: Preparation of Carbodiimide

A carbodiimide was prepared according to the formulation of Table 12.

To a four necked reaction flask outfitted with a stirrer, gas inlet, thermometer and condenser was added the contents of Charge 1 and heated to 160° C. The reaction was held until the measured isocyanate value was greater than 384 g/eq. The reaction was cooled to room temperature which was facilitated by adding Charge 2. The resulting NCO prepolymer had a measured isocyanate value of 532 g/eq and 66.3 wt. % solids. A portion of the NCO prepolymer and Charge 3 were heated to 70° C. and held for 1 hour. Charge 4 followed by Charge 5 were added and the reaction was held at 80° C. until the NCO was undetectable via IR analysis. The reaction was dispersed by adding Charge 6. The dispersed materials had a solids content of 34.2 wt. % and a theory carbodiimide equivalent weight of 646 g/eq on resin solids.

TABLE 12
Branched carbodiimide CDI-1

| Charge | Raw Material | Amount (g) |
|---|---|---|
| 1 | Desmodur ® W⁴ | 944.7 |
| | Phospholene Oxide | 2.5 |
| | Butyl Acetate | 94.4 |
| 2 | Butyl Actetate | 311.4 |
| 1 + 2 | NCO prepolymer | 319.2 |
| 3 | Dibutyltin Dilaurate | 0.036 |
| | MPEG 550⁵ | 165.0 |
| | Butyl Acetate | 8.5 |
| 4 | TMP-EO⁶ | 17.4 |
| 5 | Butyl Acetate | 1.7 |
| 6 | Deionized Water | 656 |

⁴liquid cycloaliphatic diisocyanate available from Covestro AG
⁵CARBOWAX, methoxypolyethylene glycol 550 available from Dow Chemical
⁶Trimethylolpropane ethoxylate available from Sigma Aldrich average Mₙ ~170

### Example 13: Preparation of Epoxy Polyurethane PU-5

An epoxy polyurethane, PU-5, was prepared according to the formulation of Table 13.

To a four necked reaction flask outfitted with a stirrer, gas inlet, thermometer and condenser was added the contents of Charge 1 and heated to 80° C. Charge 2 was added dropwise. The reaction was heated to 90° C. After the exotherm subsided, the reaction was held at 90° C. until the NCO was undetectable as measured by transmission Fourier Transform Infrared (FTIR) spectroscopy. The volatile content was removed under vacuum distillation resulting in a final polyurethane with a measured epoxy equivalent weight of 362 g/eq.

TABLE 13
Epoxy Polyurethane PU-5

| Charge | Raw Material | Amount (g) |
|---|---|---|
| 1 | Vestanat T ® 1890/100⁷ | 500 |
| | Dibutyltin Dilaurate | 0.32 |
| | Methyl Isobutyl Ketone | 125.0 |
| 2 | Oxiranylmethanol | 148.0 |
| | Methyl Isobutyl Ketone | 59.0 |

⁷Available from Evonik Industries, cycloaliphatic polyisocyanate based on isophorone diisocyanate, comprises an isocyanurate ring and an NCO-functionality of 3-4

### Example 14: Preparation of Epoxy Urethane PU-6

An epoxy polyurethane, PU-6, was prepared according to the formulation of Table 14.

To a four necked reaction flask outfitted with a stirrer, gas inlet, thermometer and condenser was added the contents of Charge 1 followed by Charge 2. The reaction was heated to 80° C. After the exotherm subsided, the reaction was held at 80° C. until the NCO was undetectable as measured by transmission Fourier Transform Infrared (FTIR) spectroscopy resulting in a final polyurethane with a measured solid content of 83.8 wt. % and an epoxy equivalent weight of 191 g/eq on resin solids.

TABLE 14
Epoxy Polyurethane PU-6

| Charge | Raw Material | Amount (g) |
|---|---|---|
| 1 | Isophorone Diisocyanate | 222.3 |
| | Dibutyltin Dilaurate | 0.19 |
| | Methyl Isobutyl Ketone | 74.2 |
| 2 | Oxiranylmethanol | 148.0 |
| | Methyl Isobutyl Ketone | 18.4 |

### Example 15: Liquid Coatings Curable Compositions

Example (Ex.) clear coating composition was prepared by mixing an A side and a B side. For the A side, the components of Table 15 were weighed and placed into a scintillation vial and mixed until homogenous. For the B side, the components of Table 15 were weighed and placed into a separate scintillation vial. All material amounts are in terms of weight percent unless otherwise specified.

TABLE 15
Preparation of Side A and Side B

| | | | | |
|---|---|---|---|---|
| | | | Ex. C | Ex. D |
| Components | Ex. A | Ex. B | (comparative) | (comparative) |

A Side

| | | | | |
|---|---|---|---|---|
| PU-1 | 59.77 | 49.40 | — | — |
| Acid polyester⁸ | — | — | 31.41 | 23.00 |
| DABCO 33-LV⁹ | 0.68 | 0.56 | 1.18 | 0.86 |
| BYK-333¹⁰ | 0.36 | 0.30 | 0.62 | 0.46 |
| Methyl ethyl ketone | 26.99 | 13.96 | 45.57 | 20.52 |

B Side

| | | | | |
|---|---|---|---|---|
| Denacol EX-622¹¹ | 12.20 | — | 21.22 | — |
| PU-4 | — | 35.78 | — | 55.16 |

⁸Made as a 70 wt. % solids solution of 1:0.5:0.4 weight ratio of 4-methylhexahydrophthalic anhydride:hexahydrophthalic anhydride:trimethylol
propane in 95:5 weight ratio butyl-acetate:normal propyl alcohol
⁹1,4-diazabicyclo[2.2.2]octane available from Sigma-Aldrich, Inc. (St. Louis, MO, USA)
¹⁰Silicone-containing surface additive available from BYK USA Inc. (Chester, NY, USA)
¹¹Sorbitol polyglycidyl ether available from Nagase Chemtex Corp. (Osaka, Japan)

Prior to the coating application, the corresponding amounts of the A side formulation and the B side formulation shown in Table 16 were combined and mixed thoroughly. The formulas were drawn down using an 8 mil gap square applicator on a 4″×12″ steel substrate which was precoated with an ED7100 electrocoat primer (Available from ACT Test Panels LLC (Hillsdale, MI)). The coated panels were flashed at ambient conditions for 10 minutes before being baked in a 60° C. oven for 45 minutes. Each coated panel was allowed to sit for 7 days at ambient conditions before being subjected to solvent resistance testing (Table 17).

TABLE 16
Preparation of Coating Formulas

| | A Side (wt. %) | B Side (wt. %) |
|---|---|---|
| Ex. A | 87.80 | 12.20 |
| Ex. B | 64.22 | 35.78 |
| Ex. C (comparative) | 78.78 | 21.22 |
| Ex. D (comparative | 44.84 | 55.16 |

TABLE 17
Solvent resistance results

| | MEK DR |
|---|---|
| Ex. A | 64 |
| Ex. B | 100+¹ |
| Ex. C (comparative) | 4 |
| Ex. D (comparative) | 66 |

¹Testing stopped at 100 double rubs. No observable mar or breakthrough

As seen in Table 17, Ex. A, which includes PU-1 achieves 64 MEK DR which is higher than 4 MEK DR of Ex. C which does not contain an acid in close proximity to a urethane when cured with Denacol EX-622. Additionally, Ex. B which includes PU-1 achieves 100+ MEK DR which is higher than 66 MEK DR of Ex. D which does not contain an acid in close proximity to a urethane when cured with PU-4.

### Example 16: Powder Coatings Curable Compositions

The coating formulations Ex. E-I of the present disclosure were prepared in the amounts shown in Table 18 using the following method. All values in Table 18 are given in parts by weight in grams.

Powder Gel Time: The gel time was determined according to the test method described in ASTM D4217-07. The interval (mm:ss=minutes:seconds) at which the coating powder transformed from a dry solid to a gel-like state was measured at the specified temperatures in Table 18 on a polished hot surface.

All reactions were done on a hot plate set at either 180° C., 150° C., or 130° C. Reactants were put onto the hot plate separately and allowed to melt or soften. They were then mixed and a timer set. Once the material gelled or solidified the timer was stopped and the elapsed time was recorded (Table 19).

TABLE 18
Powder coating curable compositions

| | | Ex. F | | Ex. H | |
|---|---|---|---|---|---|
| | Ex. E | (comparative) | Ex. G | (comparative) | Ex. I |
| PU-2 | 2.0 | | 2.0 | | 2.0 |
| PE-1 | | 2.0 | | 2.0 | |
| PU-5 | | | | | 2.0 |
| Triglycidyl | 0.55 | 0.93 | | | |
| isocyanurate | | | | | |
| Primid XL552¹ | | | 0.45 | 0.76 | |

¹Available from EMS-GRILTECH (Sumter, SC USA )

TABLE 19
Gel time of powder coating curable compositions

| | | Ex. F | | Ex. H | |
|---|---|---|---|---|---|
| | Ex. E | (comparative) | Ex. G | (comparative) | Ex. I |
| Gel time | 0:20 | 1:00 | 1:00 | 1:50 | 0:10 |
| (mm:ss) 180° C. | | | | | |
| Gel time | 1:15 | 6:00 | 6:00 | 13:30 | 0:30 |
| (mm:ss) 150° C. | | | | | |
| Gel time | ND | ND | ND | ND | 0:55 |
| (mm:ss) 130° C. | | | | | |

ND—not determined

As can be seen in Table 19, Ex. E, which includes PU-2, gels at 20 seconds as compared to Ex. F which does not contain an acid in close proximity to a urethane takes 1 minute. Both formulations were reacted with the same common crosslinker used in powder coatings, triglycidyl isocyanurate (TGIC). Further, even at cure temperatures down to 150° C., Ex. E gels at 1 minute 15 seconds, over 4 times faster than Ex. F.

Also seen in Table 19, Ex. G, which includes PU-2, gels at 1 minute as compared to Ex. H which does not contain an acid in close proximity to a urethane takes 1 minute 50 seconds. Both formulations were reacted with the same common crosslinker used in powder coatings, hydroxyalkylamide (Primid XL552). Further, even at cure temperatures down to 150° C., Ex. G gels at 6 minutes, over 2 times faster than Ex. H.

Also, when considering Ex I., it was surprisingly observed that the combination of PU-2 and PU-5, that include acid in close proximity to a urethane and epoxy in close proximity to a urethane, the gel time was the fastest observed and was able to gel even at 130° C., showing a significant benefit to the combination of acid in close proximity to a urethane and epoxy in close proximity to a urethane.

### Example 17: Liquid Curable Compositions

The formulations Ex. J-M were prepared in the amounts shown in Table 20 using the following method. All values in Table 20 are given in parts by weight in grams. The acid containing material was dissolved in Dowanol™ PM Glycol Ether (available from The Dow Chemical Company, Midland, MI, USA) prior to the epoxy containing material and DABCO 33LV (available from Sigma-Aldrich Inc. St. Louis, MO, USA) being added and mixed. Initial acid value and epoxy equivalent weight were recorded for each mixture. 5.0 grams of material was weighed out on a 70 millimeter diameter aluminum pan. The pans were baked in a 100° C. oven for 1 hour and allowed to sit for at ambient conditions for an additional day before calculating wt. % solids of the reacted composition based off of total remaining mass compared to known starting composition solids, an acid value (mg KOH), and epoxy equivalent weight in g/eq (Table 21).

TABLE 20
Oven Foil Pan Formulations

| | | Ex. K | | Ex. M |
|---|---|---|---|---|
| | Ex. J | (comparative) | Ex. L | (comparative) |
| PU-3 | 5.57 | | 5.74 | |
| Pripol ™ 1017¹² | | 5.49 | | 5.66 |
| PU-6 | 4.29 | 4.28 | | |
| Eponex 1510¹³ | | | 4.11 | 4.19 |
| DABCO 33 LV⁹ | 0.14 | 0.14 | 0.15 | 0.21 |
| Dowanol PM | 18.00 | 18.00 | 20.00 | 20.00 |
| Glycol Ether¹⁴ | | | | |
| AV on solids | 137.7 | 114.5 | 104.1 | 110.0 |
| EEW on solids | 453 | 455 | 457 | 467 |

¹²C36 dimer acid available from Croda International (Snaith, England, UK)
¹³Hydrogenated epoxy resin Available from Westlake Corporation (Houston, TX, USA)
⁹1,4-diazabicyclo[2.2.2]octane available from Sigma-Aldrich, Inc. (St. Louis, MO, USA)
¹⁴Available from The Dow Chemical Company (Midland, MI, USA)

Percent conversion was calculated from acid value and epoxy equivalent weight normalized for solids of the reacted material as compared to the initial solids values.

TABLE 21
Reaction Conversion

| | | Ex. K | | Ex. M |
|---|---|---|---|---|
| | | (compar- | | (compar- |
| | Ex. J | ative) | Ex. L | ative) |
| wt. % solids after | 84.27% | 92.51% | 98.10% | 98.71% |
| reaction | | | | |
| AV on resin solids | 11.8 | 20.8 | 40.2 | 59.0 |
| % conversion (AV) | 89.6% | 81.9% | 61.2% | 46.4% |
| EEW on resin solids | 3729 | 2577 | 1062 | 852 |
| % conversion (EEW) | 88.9% | 82.4% | 57.0% | 45.2% |

When PU-6 was reacted with an acid in close proximity to a urethane in Ex. J. a higher reaction conversion was observed regardless of monitoring acid value or epoxy equivalent weight when compared to Ex. K which does not include an acid in close proximity to a urethane. A similar advantage was observed when an acid in close proximity to a urethane in Ex. L was reacted with Eponex 1510 as compared to an acid not in close proximity to a urethane in Ex. M. Furthermore, when an acid in close proximity to a urethane was reacted with an epoxy in close proximity to a urethane in Ex. J, the highest conversion of the reaction was observed indicating that having a urethane in close proximity to both the epoxy and acid provide the highest reaction conversion.

### Example 18: Curable Composition Including Carbodiimide

Curable compositions were prepared according to the formulations of Table 22.

The polyurethane dispersion, water, and silicone surfactant were mixed in a 20 ml glass scintillation vial before Carbodilite V-02-L2 (available from Nisshinbo Chemical) was added and thoroughly stirred. The formulas were sprayed using a SataJet 4000 B HVLP with a WSB fluid tip on to 4″×12″ steel substrate which was precoated with an ED7100 electrocoat primer (available from ACT Test Panels LLC (Hillsdale, MI)) which had been processed and baked according to the manufacture's recommendations. The films were flashed at ambient conditions for 15 minutes before being baked in a 60° C. oven for 40 minutes. Each coated panel was allowed to sit for 7 days at ambient conditions before being subjected to solvent resistance testing.

TABLE 22
Curable Composition Ex. N-P

| | Ex. N | Ex. O | Ex. P |
|---|---|---|---|
| Component | Amount (g) | Amount (g) | Amount (g) |
| PUD-1 | 35.0 | 0 | 0 |
| PUD-3 | 0 | 7.5 | 0 |
| PUD-6 | 0 | 0 | 5.0 |
| Silicone Surfactant¹⁵ | 0 | 0.1 | 0.1 |
| Deionized Water | 4.2 | 1.7 | 3.7 |
| Carbodiimide¹⁶ | 21.2 | 0 | 0 |
| Carbodiimide¹⁷ | 0 | 3.0 | 0 |
| CDI-1 | 0 | 0 | 7.5 |

¹⁵BYK348 available from BYK.
¹⁶Carbodilite V-02-L2 available from Nisshinbo Chemical.
¹⁷Carbodilite E-09S available from Nisshinbo Chemical

### Example 19: Curable Composition Including Epoxy

Curable compositions were prepared according to the formulations of Table 23.

The polyurethane dispersion, water, and silicone surfactant were mixed before Denacol EX 614B (available from Nagase America LLC) was added and thoroughly stirred. The formulas Example D through F were drawn down using a 8 mil gap square applicator on to 4″×12″ steel substrate which was precoated with an ED6421 HE electrocoat primer (available from ACT Test Panels LLC (Hillsdale, MI)), or with an ED7100 electrocoat primer (available from ACT Test Panels LLC (Hillsdale, MI)). The films were flashed at ambient conditions for 15 minutes before being baked in a 140° C. oven for 60 minutes. Example G was applied using #26 wire drawdown bar over a 0.0080-inch-thick 5182-H48 aluminum substrate pretreated with Cr-VI Henkel 702 Pretreatment (Available from Alcoa Weirton, WV). The coating was then immediately placed in Hendinair oven set at 281° C., a belt speed of 51 rpm and a fan speed of 9 rpm. The settings of the Hendinair oven were used to achieve a peak metal temperature of 240° C. for a time of 10 seconds. Each coated panel was allowed to sit for 7 days at ambient conditions before being subjected to solvent resistance testing as shown in Table 26.

TABLE 23
Curable Composition Ex. Q-T

| | Ex. Q | Ex. R | Ex. S | Ex. T |
|---|---|---|---|---|
| Component | Amount (g) | Amount (g) | Amount (g) | Amount (g) |
| PUD-3 | 7.5 | 0 | 0 | 0 |
| PUD-5 | 0 | 10 | 0 | 0 |
| PUD-6 | 0 | 0 | 10 | 25 |
| Silicone | 0.10 | 0.09 | 0.09 | 0.23 |
| Surfactant¹⁵ | | | | |
| DI Water | 2.6 | 4.4 | 6.2 | 46.6 |
| Epoxy¹⁶ | 0.7 | 1.3 | 1.3 | 3.2 |

¹⁵BYK348 available from BYK.
¹⁶Denacol EX-614B available from Nagase America LLC.

### Example 20: Curable Composition Including Oxazoline

Curable compositions were prepared according to the formulations of Table 24.

The polyurethane dispersion, water, and silicone surfactant were mixed in a 20 ml glass scintillation vial before Epocros WS-500 (available from Nippon Shokubai CO. LTD.) was added and thoroughly stirred. The formulas were drawn down using an 8 mil gap square applicator on to 4″×12″ steel substrate which was precoated with an ED6421 HE electrocoat primer (available from ACT Test Panels LLC (Hillsdale, MI)) which had been processed and baked according to the manufacture's recommendations. The films were flashed at ambient conditions for 15 minutes before being baked in a 100° C. oven for 45 minutes. Each coated panel was allowed to sit for 1 day at ambient conditions before being subjected to solvent resistance testing.

TABLE 24
Curable Composition Ex. U-W

| | Ex. U | Ex. V | Ex. W |
|---|---|---|---|
| Component | Amount (g) | Amount (g) | Amount (g) |
| PUD-3 | 7.5 | 0 | 0 |
| PUD-5 | 0 | 5.0 | 0 |
| PUD-6 | 0 | 0 | 5.0 |
| Silicone | 0.1 | 0.05 | 0.05 |
| Surfactant¹⁵ | | | |
| Water | 1.5 | 2 | 2.1 |
| Oxazoline¹⁷ | 2.4 | 2.1 | 2.2 |

¹⁵BYK348 available from BYK.
¹⁷Epocros ™ WS-500 available from Nippon Shokubai CO. LTD.

### Example 21: Curable Composition Including Aziridines

Curable compositions were prepared according to the formulations of Table 25.

The polyurethane, NeoAdd PAX-523 (available from Covestro AG), and methyl ethyl ketone were mixed and thoroughly stirred. The formulas were drawn down using an 8 mil gap square applicator on to 4″×12″ steel substrate which was precoated with an ED7100 electrocoat primer (available from ACT Test Panels LLC (Hillsdale, MI)) which had been processed and baked according to the manufacture's recommendations. The films were flashed at ambient conditions for 5 minutes before being baked in a 140° C. oven for 30 minutes. Each coated panel was allowed to sit for 7 days at ambient conditions before being subjected to solvent resistance testing.

TABLE 25
Curable Composition Ex. X-Y

| | Ex. X | Ex. Y |
|---|---|---|
| Component | Amount (g) | Amount (g) |
| PUD-2 | 32.3 | 0 |
| PUD-4 | 0 | 45.9 |
| Polyazirdine¹⁸ | 20.1 | 17.9 |
| Methyl Ethyl Ketone | 47.6 | 36.2 |

¹⁸NeoAdd PAX-523 available from Covestro AG

### Example 22: Curable Composition Properties

A Solvent Resistance Test was performed on each example curable composition of Tables 22-25 using the procedure described in the description above. The results of the Solvent Resistance Test as recorded in MEK double rubs can be seen in Table 26, below.

TABLE 26
Curable composition N-Y

| Example | MEK Double Rubs |
|---|---|
| N | 100 |
| O | 100 |
| P | 100 |
| Q | 100 |
| R | 100 |
| S | 100 |
| T | 100 |
| U | 100 |
| V | 100 |
| W | 100 |
| X | 100 |
| Y | 100 |

As can be seen in the above examples, a variety of polyurethanes that include acid functional groups in close proximity to the urethane were used to create curable compositions as shown by excellent solvent resistance according to the Solvent Resistance Test. Further, it was demonstrated that the acid functional groups in close proximity to a urethane can be installed using a variety of synthetic approaches, all of which yielded curable moieties. Additionally, a number of different curing agents or crosslinkers, reactive with the acid functional groups, were demonstrated as part of the curable compositions.

### Example 23: Reactive Composition

The formulations Ex. Z-CC were prepared in the amounts shown in Table 27 using the following method. All values in Table 27 are given in parts by weight in grams. The acid containing material was dissolved in dimethyl sulfoxide-d6, followed by addition of the epoxy containing material and the catalyst, DABCO 33LV (available from Sigma-Aldrich Inc. St. Louis, MO, USA) The resulting formulation was mixed on a vortex mixer and transferred to a 5 mm NMR tube to be analyzed on a Bruker AVIII HD 500 MHz NMR (Nuclear Magnetic Resonance) instrument at 100° C. Proton NMR were collected (16 scans, 15 s relaxation delay) as the reaction progressed. A minimum of 14 data points were collected for each formulation to obtain relative rate constants. Note that the signals at each data point is the average of 16 scans. For Ex. Z and Ex. BB the absolute integral of the epoxy peak signal at 3.1 ppm (corresponding to the methine protons in the epoxy ring) was monitored. For Ex. AA and Ex. CC the absolute integral of the epoxy peak signal at 2.8 ppm (corresponding to the methylene protons in the epoxy ring) was monitored. These signals were chosen for the analysis due to minimal signal overlap with other protons in the systems. The decrease in the absolute integral with respect to time was plotted and fitted to a first order exponential decay curve:

$$[ A ] = {[ A ]}_{o} {e}_{{app}^{t}}^{- k}$$

Here [A] is the absolute integral of the signals corresponding to the epoxy ring-opening reaction. The apparent rate constant, kₐₚₚ (s⁻¹), could thus be readily obtained from the curve fit (Table 28), thus allowing for relative comparisons between the kₐₚₚ of the four formulations.

TABLE 27
Reactive Compositions Z-CC

| | | | Ex. BB | Ex. CC |
|---|---|---|---|---|
| | Ex. Z | Ex. AA | (comparative) | (Comparative) |
| PU-3 | 0.49 | 0.75 | | |
| Isononanoic acid | | | 0.40 | 0.67 |
| PU-6 | 0.50 | | 0.58 | |
| 1,2,7,8 diepoxy octane | | 0.23 | | 0.30 |
| DABCO 33 LV | 0.011 | 0.017 | 0.013 | 0.022 |
| Dimethyl sulfoxide-d6 | 2.00 | 2.00 | 2.00 | 2.00 |

TABLE 28
Relative Rate Constants for Ex. Z-CC

| | | | Ex. BB | Ex. CC |
|---|---|---|---|---|
| | Ex. Z | Ex. AA | (comparative) | (comparative) |
| kₐₚₚ | 1.99 × 10⁻⁴ | 1.73 × 10⁻⁴ | 1.74 × 10⁻⁴ | 1.12 × 10⁻⁴ |

As demonstrated in Table 28 an acid in close proximity to a urethane (Ex. Z) reacts faster with an epoxy in close proximity to a urethane when compared to an acid not in close proximity to a urethane (Ex. BB) Similarly, an acid in close proximity to a urethane (Ex. AA) reacts faster with an epoxy not in close proximity to a urethane when compared to an acid not in close proximity to a urethane (Ex. CC). Additionally, when an acid is in close proximity to a urethane and the epoxy is in close proximity to a urethane the relative reaction is the fastest, as demonstrated in Ex. Z.

Whereas particular examples of the compositions and methods according to this disclosure have been described above for purposes of illustration, it will be evident to those skilled in the art that numerous variations of the details of the present disclosure may be made without departing from the description as defined in the appended claims.

1. A reactive composition comprising:
a first compound comprising from 1 to 12 carboxylic acid functional groups according to structure (I): 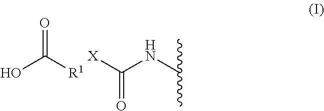
wherein R¹ is a C₁ to C₆, such as a C₁ to C₄ or C₁ to C₃ linear or branched alkyl group and X is O, S or NR², wherein R² is H, methyl, ethyl, propyl or isopropyl; and
a second compound comprising a functional group reactive with the carboxylic acid functional groups in the first compound.

2. The reactive composition according to claim 1, wherein the first compound comprises a polymer backbone and/or a base molecule comprising a molecular chain of from 6 to 60 linear, branched, cyclic and/or aromatic carbon atoms and can optionally comprise a hetero atom comprising O, S or NR⁵, wherein R⁵ is H, methyl, ethyl, propyl or isopropyl and wherein the carboxylic acid functional groups comprise an end group and/or pendant group from the polymer backbone and/or the base molecule; and/or
wherein the base molecule optionally comprises a cyclic moiety comprising from 5 to 14 ring units, wherein, optionally some of the ring units comprise a hetero atom and the remaining ring units comprise carbon.

3. The reactive composition according to claim 1, wherein the first compound comprises a polymer comprising a carboxylic acid group having an acid value of from 10 mg KOH to 250 mg KOH on solids according to ASTM D 4662-15.

4. The reactive composition according to claim 1, wherein the carboxylic acid functional group is the reaction product of an isocyanate and a compound comprising a carboxylic acid group and a hydroxyl, a carboxylic acid group and a thiol and/or a carboxylic acid group and an amine.

5. The reactive composition according to claim 1, wherein the first compound is present in the composition at from 10 wt. % to 85 wt., where wt. % is based on total resin solids of the composition.

6. The reactive composition according to claim 1, wherein the second compound comprises a carbodiimide, an epoxy, a hydroxyl, a thiol, a primary amine, a secondary amine, a hydroxyl amine, an oxazoline, hydroxyalkyl amide, hydroxyalkyl urea, and/or an aziridine functional group.

7. The reactive composition according to claim 1, wherein the second compound comprises an epoxy functional compound comprising a structure according to structure (II): 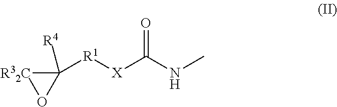
wherein R¹ is a C₁ to C₆ linear or branched alkyl group and X is O, S or NR², wherein R² is H, methyl, ethyl, propyl or isopropyl;
wherein each R³ and R⁴ can independently be a H, a C₁ to C₅ linear or branched alkyl group, a base molecule comprising a molecular chain of from 6 to 60 linear, branched, cyclic and/or aromatic carbon atoms, and/or a polymer backbone and can optionally comprise a hetero atom comprising O, S or NR⁵, wherein R⁵ is H, methyl, ethyl, propyl or isopropyl, optionally wherein one R³ and R⁴ can form part of a polymer backbone and/or a base molecule comprising a molecular chain of from 6 to 60 linear, branched, cyclic and/or aromatic carbon atoms, and
wherein each R³ and R⁴ can independently optionally comprise a hetero atom comprising O, S or NR⁶, wherein R⁶ is H, methyl, ethyl, propyl or isopropyl; and
wherein the epoxy functional compound comprises an end group and/or a pendant group from the polymer backbone and/or the base molecule.

8. The reactive composition according to claim 1, wherein the first compound and/or the second compound comprise a polymer comprising urethane, urea, thiourea, or thiourethane repeat groups, (meth)acrylate repeat groups, ester repeat groups, amide repeat groups, and/or carbonate repeat groups.

9. The reactive composition according to claim 1, wherein the second compound is present in the composition at from 15 wt. % to 90 wt. %, where wt. % is based on total resin solids of the composition.

10. The reactive composition according to claim 1 comprising a catalyst;
wherein the catalyst comprises zinc, a phosphine, an amine, a quaternary ammonium group, a phosphonium, and/or a quaternary phosphonium group; and/or
wherein the catalyst is present at from 0.05 wt. % to 2 wt. %, where wt. % is based on the weight of the reactive composition.

11. The reactive composition according to claim 1, wherein the reactive composition is a curable composition; wherein the first compound comprises more than two carboxylic acid groups and/or the second compound comprises more than two functional groups reactive with the carboxylic acid functional groups.

12. The reactive composition according to claim 1 in the form of a liquid composition, wherein the liquid composition is a liquid at ambient conditions and is solvent free or the liquid composition comprises from 20 to 80 wt. % solvent, based on the weight of the reactive composition, wherein the solvent comprises water and/or organic solvent; and optionally wherein the reactive composition comprises a neutralizing amine at a level of from 40-120%, total neutralization, based on the number of acid groups in the reactive composition.

13. The reactive composition according to claim 1 reacted to form a reaction product as a component of a composition.

14. The reactive composition according to claim 13, wherein the reaction product has a molecular weight of less than 2,000 g/mol;
wherein the reaction product optionally comprises a chiral center chiral center, a stereoisomer, an enantiomer, and/or diastereomer; and/or
wherein the reaction product is optionally a racemic mixture.

15. The reactive composition according to claim 13, wherein the reaction product is a polymer having a weight average molecular weight of from greater than 2,000 to 50,000 g/mol determined by gel permeation chromatography using polystyrene standards.

16. A method of coating a substrate comprising applying the reactive composition of claim 1 over at least a part of a substrate using spray coating, roller coating, coil coating, dip coating, precision coating, or spin coating techniques and curing the reactive composition to form a cured layer;
wherein the cured layer is optionally part of a multi-layer coating, wherein the cured layer comprises a primer coat, a basecoat or color coat layer and/or a clear coat layer; and
wherein the reactive composition is reacted at a temperatures of from 0° C. to 260° C. for from 5 seconds to 168 hours; and
wherein optionally, prior to reacting the reactive composition, it is flashed at a temperature of from 10° C. to 80° C. for from 5 to 60 minutes.

17. The method according to claim 16, wherein the reactive composition reacts when less energy is applied, such as at a lower temperature, than a composition that does not include a compound comprising the carboxylic acid functional groups according to structure (I); and/or
wherein the reactive composition reacts faster than a composition that does not include a compound comprising the carboxylic acid functional groups according to structure (I) at the same temperature; and/or
wherein the reactive composition comprises a first compound comprising structure (I) and a second compound comprising structure (II) and reacts when less energy is applied, such as at a lower temperature, than a composition that either does not include a compound comprising the carboxylic acid functional groups according to structure (I) or includes a compound comprising the carboxylic acid functional groups according to structure (I) but not a second compound comprising structure (II); and/or
wherein the reactive composition reacts faster than a composition that does not include a compound comprising the carboxylic acid functional groups according to structure (I) at the same temperature than a composition that either does not include a compound comprising the carboxylic acid functional groups according to structure (I) or includes a compound comprising the carboxylic acid functional groups according to structure (I) but not a second compound comprising structure (II)
wherein structure (II) comprises a structure according: 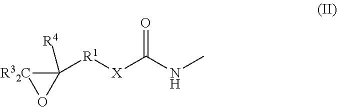
wherein R¹ is a C₁ to C₆ linear or branched alkyl group and X is O, S or NR², wherein R² is H, methyl, ethyl, propyl or isopropyl;
wherein each R³ and R⁴ can independently be a H, a C₁ to C₅ linear or branched alkyl group, a base molecule comprising a molecular chain of from 6 to 60 linear, branched, cyclic and/or aromatic carbon atoms, and/or a polymer backbone and can optionally comprise a hetero atom comprising O, S or NR⁵, wherein R⁵ is H, methyl, ethyl, propyl or isopropyl, optionally wherein one R³ and R⁴ can form part of a polymer backbone and/or a base molecule comprising a molecular chain of from 6 to 60 linear, branched, cyclic and/or aromatic carbon atoms, and
wherein each R³ and R⁴ can independently optionally comprise a hetero atom comprising O, S or NR⁶, wherein R⁶ is H, methyl, ethyl, propyl or isopropyl; and
wherein the epoxy functional compound comprises an end group and/or a pendant group from the polymer backbone and/or the base molecule.

18. The method according to claim 16, wherein the reactive composition is applied to at least a part of a substrate to form an article.

19. An article of manufacture made by ambient reactive extrusion, comprising
the reactive composition according to claim 1,
wherein the reactive composition is applied as multiple layers,
wherein a first reactive composition is applied as a first layer;
wherein a second reactive composition is applied to a surface of the first reactive composition, making up a second layer; and/or
wherein the article forms at least part of a vehicle, an article of manufacture, a consumer electronic device, a consumer appliance, a pavement, a road marking or a structure, such as a component of modular housing.
